(19) United States
(12) Patent Application Publication
(10) Pub. No.: US 2016/0246942 A1
(43) Pub. Date: Aug. 25, 2016

(54) NARCOTICS MONITORING SYSTEM AND METHOD

(71) Applicant: American Institute of Toxicology, Inc. D/b/a AIT Laboratories, Indianapolis, IN (US)

(72) Inventors: Bryston Cutter, Aurora, IN (US); Ronald Scott LaNeve, Carmel, IN (US); Gina Marie Cooper, Nineveh, IN (US)

(21) Appl. No.: 15/010,753

(22) Filed: Jan. 29, 2016

Related U.S. Application Data
(60) Provisional application No. 62/109,363, filed on Jan. 29, 2015.

(51) Int. Cl. G06F 19/00

(52) U.S. Cl. CPC G06F 19/3456; G06F 19/322; G06F 19/3431

(57) ABSTRACT

A method for monitoring medication intake activity comprising receiving patient data, receiving prescription data, receiving drug data, receiving risk element data and calculating, by a processor, a patient's risk level for abusing controlled substances based on the drug data, the prescription data, the risk element data, and the patient data

### PRIORITY CLAIM

This application claims priority to U.S. 62/109,363 filed on Jan. 29, 2015, the entire disclosure of which is hereby expressly incorporated by reference herein.

### TECHNICAL FIELD OF THE DISCLOSURE

The present disclosure relates to a method and system for medication monitoring, and more particularly, a method and system for analyzing and monitoring patients who are prescribed narcotics.

### BACKGROUND OF THE DISCLOSURE

Generally, toxicology testing is performed on blood and urine to determine the amount of medication or other substances in a patient. However, toxicology testing for pain medication is getting less profitable due to Medicare reductions. Thus, to more cost effectively determine toxicology of a patient, medication intake must be tracked and recorded. However, medication tracking can be time consuming and burdensome.

Thus, it would be advantageous to have a system and method for monitoring patients' use of narcotics, wherein the system and method are able to track and analyze patients' medication intake.

### SUMMARY OF THE DISCLOSURE

In one embodiment of the present disclosure, a method for monitoring medication intake activity is provided. The method comprises receiving patient data, receiving prescription data, receiving drug data, receiving risk element data, and calculating, by a processor, a patient's risk level for abusing controlled substances based on the drug data, the prescription data, the risk element data, and the patient data.

In one aspect of the method, the method further comprises comparing the prescription data with the drug data.

In another aspect of the method, the risk element data includes a quantifiable set of answers.

In a further aspect of the method, the method further comprises signaling when a patient is scheduled to receive a next activity based on an evaluation of the prescription data and the drug data.

In another aspect of the method, the patient data includes a name, an identification number, a date of birth, a gender and an age.

In another aspect of the method, the prescription data includes a date, a name, a type, a dosage, a frequency, a prescribing physician and a length of use.

In another aspect of the method, the drug data includes a name, a dosage and at least one classification.

In another aspect of the method, at least one of the prescription data and the drug data include at least one controlled substance.

In a further aspect of the method, the method further comprises calculating a morphine equivalent dose of the at least one controlled substance.

In another aspect of the method, the method further comprises storing the patient data, the prescription data and the drug data in a database.

In another aspect of the method, the method further comprises providing recommendations for future treatment based on at least one of the patient data, the prescription data and the drug data.

In a further aspect of the method, the method further comprises scheduling a next event for determining the patient's subsequent risk level based on the patient's current risk level.

In another embodiment of the present disclosure, a system comprises a processor, and a non-transitory, computer-readable storage medium including installation software which installs medication monitoring software. The medication monitoring software includes an information database stored on the computer-readable medium accessible by the installation software and having a plurality of files, wherein at least one of the plurality of files contains patient data, at least one of the plurality of files contains prescription data of a patient, and at least one of the plurality of files contains medication data of the patient, and a plurality of computer-readable instructions stored on the computer-readable medium accessible by the processor. When the plurality of computer-readable instructions are executed by the processor, the instructions enable the processor to receive a request to perform the installation of the medication monitoring software, install the medication monitoring software in response to the request to perform the installation, determine a risk level for the patient by performing a comparison between the patient's prescription data contained in the information database and the patient's medication data contained in the information database, and display the risk level via an output device.

In another aspect of the system, the output device is a display of a computing device housing the processor.

In another aspect of the system, the system is configured to periodically change the status of a toxicology lab test report.

In a further aspect of the system, the executed plurality of computer readable instructions may further enable the processor to signal when a patient is scheduled to receive a next activity based on an evaluation of the prescription data and the drug data.

In another aspect of the system, the system is configured to provide recommendations for future treatment based on at least one of the patient data, the prescription data and the drug data.

In another aspect of the system, the risk level is a score, the score being within one of a range signifying a low risk, a range signifying a medium risk and a range signifying a high risk.

In a further aspect of the system, the executed plurality of computer readable instructions may further enable the process to schedule a subsequent determination of a risk level based on the patient's current determined risk level.

In a further embodiment of the present disclosure, a non-transitory computer-readable data storage medium comprising instructions that, when executed by a processor, cause the processor to perform acts is provided. The acts the processor perform comprise receiving patient data, receiving prescription data, receiving drug data, receiving risk element data, and calculating a patient's risk level for abusing controlled substances based on the drug data, the prescription data, the risk element data, and the patient data.

### BRIEF DESCRIPTION OF THE DRAWINGS

FIG. 1 is a schematic view of a system for monitoring medication intake of the present disclosure;

FIG. 2 is a flow chart of a method for monitoring medication intake of the present disclosure;

FIG. 3 is a graphical user interface relating to a patient profile form of the present disclosure;

FIG. 4 is a graphical user interface relating to an insurance provider tree of the present disclosure;

FIG. 5 is a graphical user interface relating to a diagnosis tree of the present disclosure;

FIG. 6 is a graphical user interface relating to a medication tree of the present disclosure;

FIG. 7 is a graphical user interface relating to a patient database form of the present disclosure;

FIG. 8 is a graphical user interface relating to a drug data form of the present disclosure;

FIG. 9 is a graphical user interface relating to a Prescription Registry Check form of the present disclosure;

FIG. 10 is a graphical user interface relating to a Prescription Registry History Item form of the present disclosure;

FIG. 11 is a graphical user interface relating to details of a Prescription Registry History Item of the present disclosure;

FIG. 12 is a graphical user interface relating to a Prescription Registry History list of the present disclosure;

FIG. 13A is a graphical user interface relating to an embodiment of a Risk Assessment Tool of the present disclosure;

FIG. 13B is a graphical user interface relating to a Risk Assessment Tool history of the present disclosure;

FIG. 14 is a graphical user interface relating to a Controlled Substance Agreement history of the present disclosure;

FIG. 15 is a graphical user interface relating to a Controlled Substance Agreement history item of the present disclosure;

FIG. 16 is a graphical user interface relating to a Toxicology Lab Testing new record form of the present disclosure;

FIG. 17 is a graphical user interface relating to a Reported Test form of a Toxicology Lab Testing form of the present disclosure;

FIG. 18 is a graphical user interface relating to a Toxicology Lab Result form of the present disclosure;

FIG. 19 is a graphical user interface relating to a Medication Reconciliation History form of the present disclosure;

FIG. 20 is a graphical user interface relating to a Medication Reconciliation History item form of the present disclosure;

FIG. 21 is a graphical user interface relating to a Medication Reconciliation drug entry form of the present disclosure;

FIG. 22 is a graphical user interface relating to a Networks tab of a System Administrator Options form of the present disclosure;

FIG. 23 is a graphical user interface relating to a Users Database tab of a System Administrator Options form of the present disclosure;

FIG. 24 is a graphical user interface relating to a Medications Tree tab of a System Administrator Options form of the present disclosure;

FIG. 25 is a graphical user interface relating to a Medication entry form of the Medication Tree tab of FIG. 24;

FIG. 26 is a graphical user interface relating to a Scenario Definitions for Prescription Registry Check form of a Scenarios tab of a System Administrators Options form the present disclosure;

FIG. 27 is a graphical user interface relating to a Users Database tab of a Network Administrator Options form of the present disclosure;

FIG. 28 is a graphical user interface relating to an Add User form of the Users Database tab of the Network Administrator Options form of FIG. 27;

FIG. 29 is a graphical user interface relating to an Insurance Providers list of a Network Administrator Options form of the present disclosure;

FIG. 30 is a graphical user interface relating to a Risk Classification tab of a Network Administrator Options form of the present disclosure;

FIG. 31 is a graphical user interface relating to a Narcotics Monitoring Activities tab of a Network Administrator Options form of the present disclosure;

FIG. 32 is a graphical user interface relating to a Risk Assessment Tool settings form of the present disclosure;

FIG. 33 is a graphical user interface relating to a Controlled Substances Risk Assessment Preview form of the present disclosure;

FIG. 34 is a graphical user interface relating to a Multiple Choice Question form of the present disclosure;

FIG. 35 is a graphical user interface relating to a Prescription Registry Check Settings form of the present disclosure;

FIG. 36 is a graphical user interface relating to a Controlled Substance Agreement Settings form of the present disclosure;

FIG. 37 is a graphical user interface relating to a Toxicology Lab Testing Settings form of the present disclosure;

FIG. 38 is a graphical user interface relating to a Medication Reconciliation Settings form of the present disclosure;

FIG. 39 is a graphical user interface relating to a Concern Level form of the present disclosure;

FIG. 40 is a graphical user interface relating to a Summary Report of the present disclosure;

FIG. 41 is a graphical user interface relating to an Activities Report of the present disclosure;

FIG. 42 is a graphical user interface relating to another Activities Report of the present disclosure;

FIG. 43 is a graphical user interface relating to a Reports tab of a System Administrator Options form of the present disclosure;

FIG. 44 is a graphical user interface relating to a Medication Reconciliation activity history list of the present disclosure;

FIG. 45 is another graphical user interface relating to the Reports tab of the System Administrator Options form of the present disclosure;

FIG. 46 is a graphical user interface relating to a Reports tab of a Network Administrator Options form of the present disclosure;

FIG. 47 is a graphical user interface relating to a Controlled Substances Prescribers tab of a Network Administrator Options form of the present disclosure;

FIG. 48 is a graphical user interface relating to a Diagnoses tab of a Network Administrator Options form of the present disclosure;

FIG. 49 is a graphical user interface relating to a Medications tab of a Network Administrator Options form of the present disclosure; and

FIG. 50 is a graphical user interface relating to a Notes form of the present disclosure.

### DETAILED DESCRIPTION OF THE DRAWINGS

The embodiments disclosed below are not intended to be exhaustive or limit the disclosure to the precise form disclosed in the following detailed description. Rather, the embodiments are chosen and described so that others skilled in the art may utilize its teachings.

One of ordinary skill in the art will realize that the embodiments provided can be implemented in hardware, software, firmware and/or a combination thereof. Programming code according to the embodiments can be implemented in any viable programming language such as C, CII, HTML, XTML, JAVA or any other viable high-level programming language, or a combination of a high-level programming language and a lower level programming language.

In certain embodiments, the system 100 includes one or more processors, evaluators, and/or determiners that functionally execute the operations of the system 100. The description herein including processors, evaluators, and/or determiners emphasizes the structural independence of certain aspects of the system 100, and illustrates one grouping of operations and responsibilities of the system. Other groupings that execute similar overall operations are understood within the scope of the present application. Processors, evaluators, and/or determiners may be implemented in hardware and/or as computer instructions on a non-transient computer readable storage medium, and may be distributed across various hardware or computer based components.

Certain operations described herein include operations to interpret and/or to determine one or more parameters or data structures. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

Example and non-limiting implementation elements that functionally execute the operations of the system include datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, and/or digital control elements.

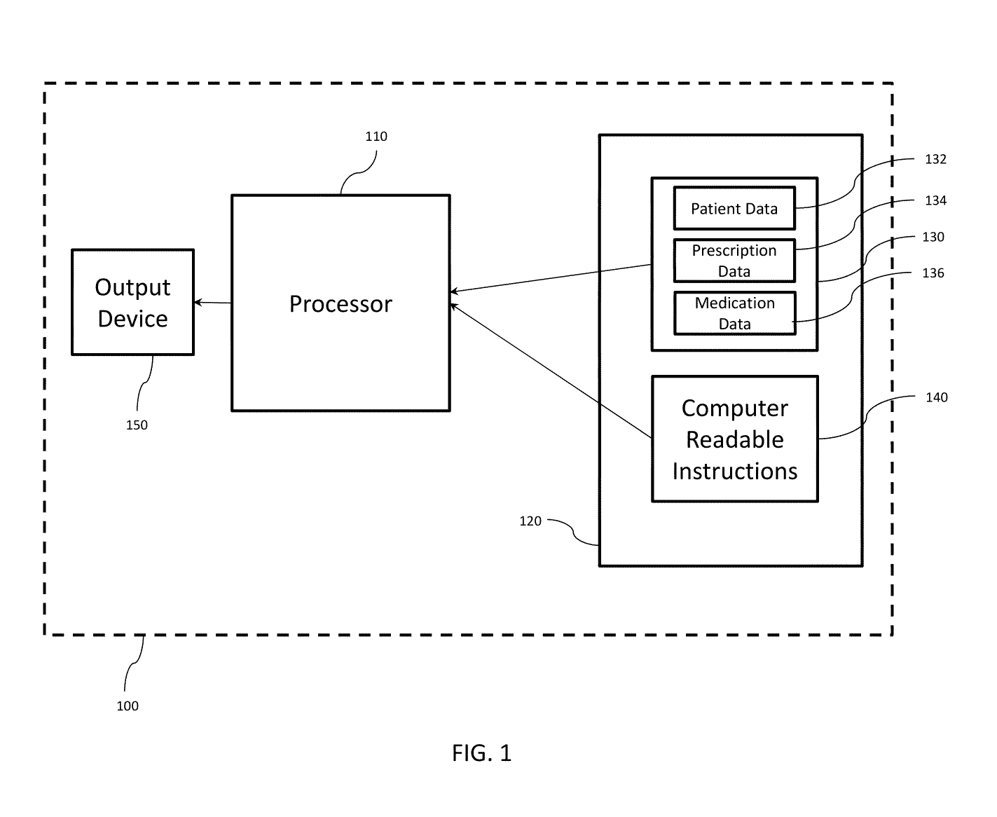

Referring to FIG. 1, a system 100 for monitoring medication intake generally includes a processor 110 and a non-transitory, computer-readable storage medium 120. Non-transitory, computer-readable storage medium 120 generally includes installation software which installs medication monitoring software. The medication monitoring software generally includes an information database 130 stored on the computer-readable medium accessible by the installation software and a plurality of computer-readable instructions 140 stored on the computer-readable medium accessible by processor 110. Information database 130 generally includes a plurality of files, wherein at least one of the plurality of files contains patient data 132, at least one of the plurality of files contains prescription data 134 of the patient, and at least one of the plurality of files contains medication data 136 of the patient. The plurality of computer-readable instructions, when executed by processor 110, enable processor 110 to receive a request to perform the installation of the medication monitoring software, install the medication monitoring software in response to the request to perform the installation, determine a risk level for the patient by performing a comparison between the patient's prescription data contained in information database 130 and the patient's medication data contained in information database 130, and display the risk level via an output device 150. In various embodiments, processor 110 may include at least one evaluator and/or determiner to carry out the plurality of computer-readable instructions. In various embodiments, output device 150 may be a display of a computing device housing processor 110. Furthermore, system 100 may be configured to periodically change the status of a toxicology lab test report (discussed below). Additionally, in various embodiments, the computer-readable instructions 140 may be executed such that processor 110 is enabled to signal when the patient is scheduled to receive a next activity based on an evaluation of the prescription data 134 and the drug data 136.

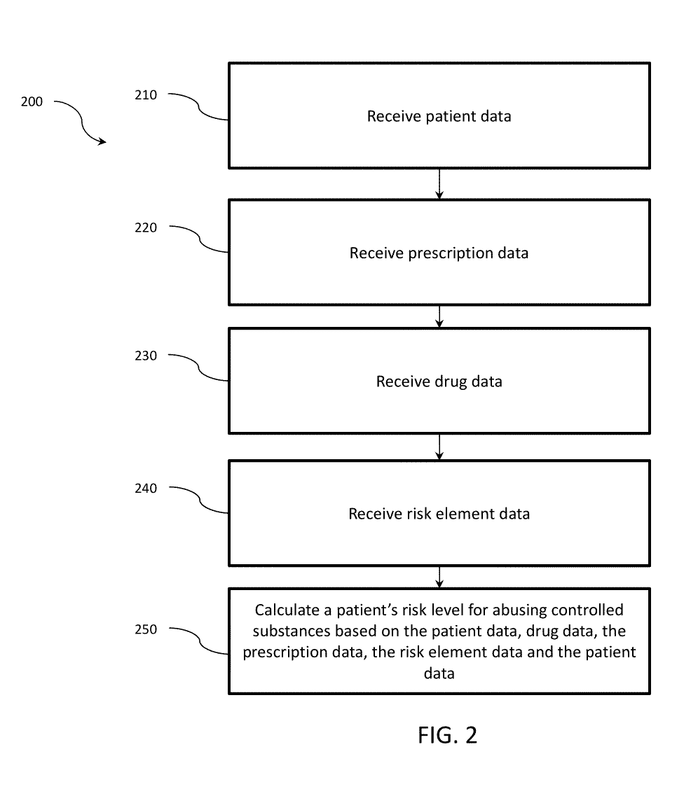

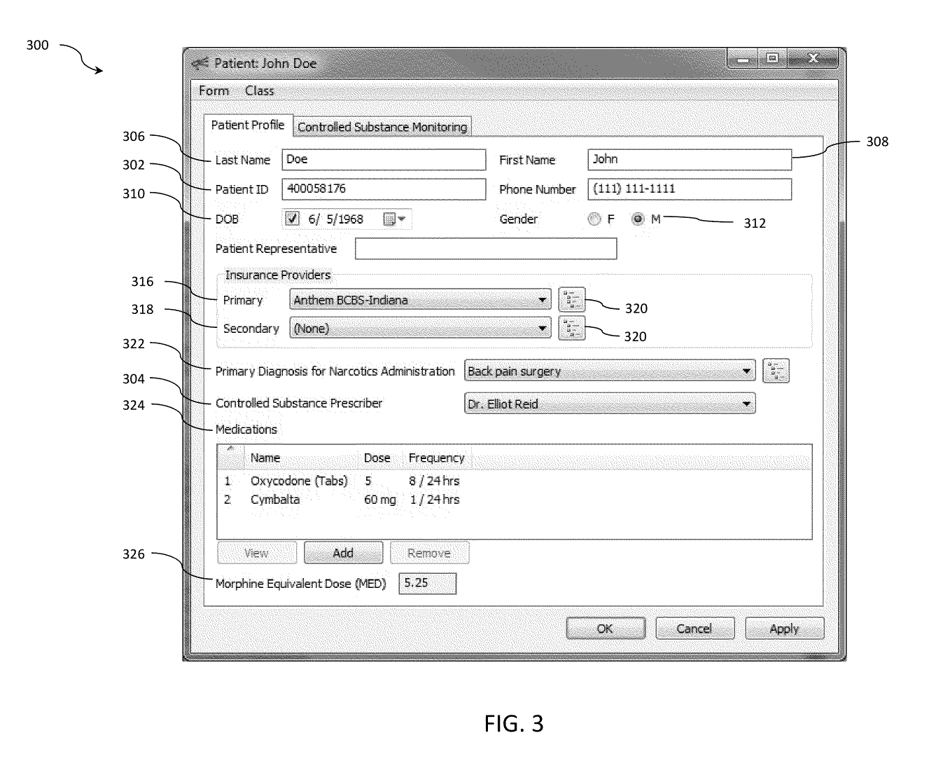

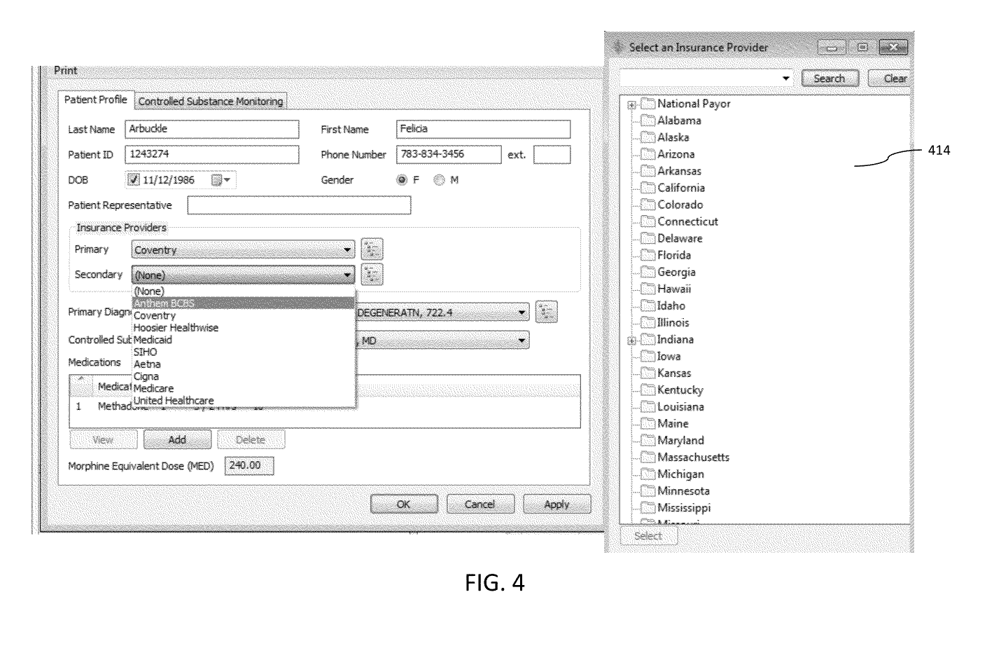

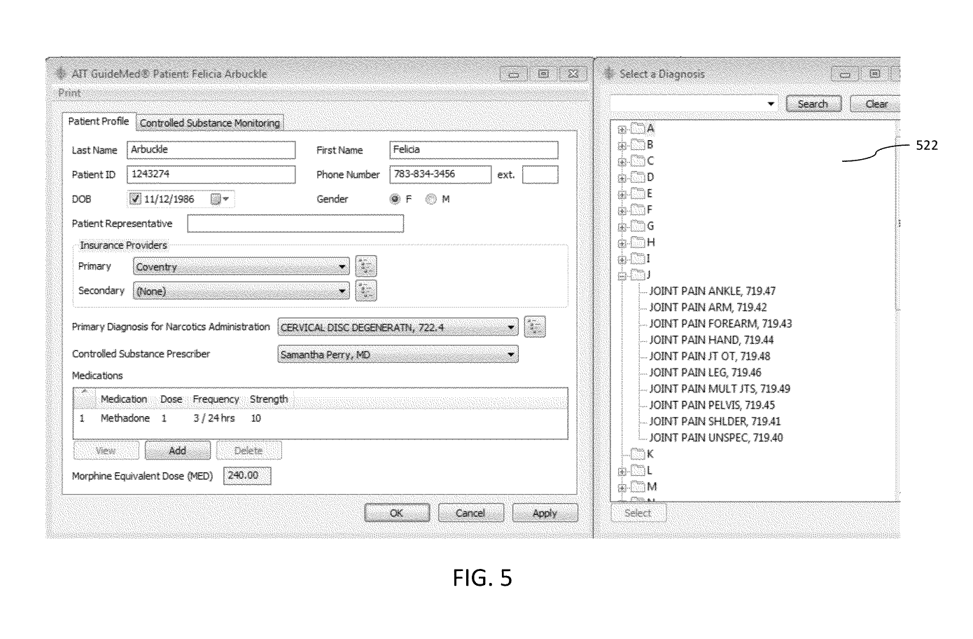

FIG. 2 illustrates a method 200 of monitoring medication intake activity according to various embodiments. Method 200 may include receiving patient data (step 210). Patient data received may include a patient's name, an identification number, which may be network-based, a date of birth, a gender and an age, among other things. A patient profile form 300, as shown in FIG. 3, may be used for entering patient information into database 130. Patient profile form 300 generally contains basic information about a given patient. The patient profile form 300 will have several mandatory fields including last name 306, first name 308, date of birth 310, gender 312, and controlled substance prescriber 304. These mandatory fields will be denoted as mandatory by a red asterisk. If any of these fields have been left empty, the nurse will not be able to save any changes to the patient's profile. Once completed, however, the asterisk will no longer be shown. Additionally, the patient profile form 300 may also include a patient identification 302, which will be network-based, but will not be automatically generated by the form when first created. Each network will have their own system for creating patient identifications, and the patient identification 302 will be assigned once created. A controlled substance prescriber 304 will also be network-based. However, a method for choosing insurance providers will be the same for all networks. There will be a drop-down for both primary insurance providers 316 and secondary insurance providers 318, which will contain all of the accepted insurance providers in the state in which the patient is registered. However, there will also be a button 320 to the right of each drop-down that allows the user entering the patient's information to choose an insurance provider from any state from an insurance provider tree 414 (see FIG. 4). Additionally, a Primary Diagnosis for Narcotics Administration will be chosen from a diagnosis tree 522 in a similar manner to insurance providers chosen from insurance providers tree 414 (see FIG. 5).

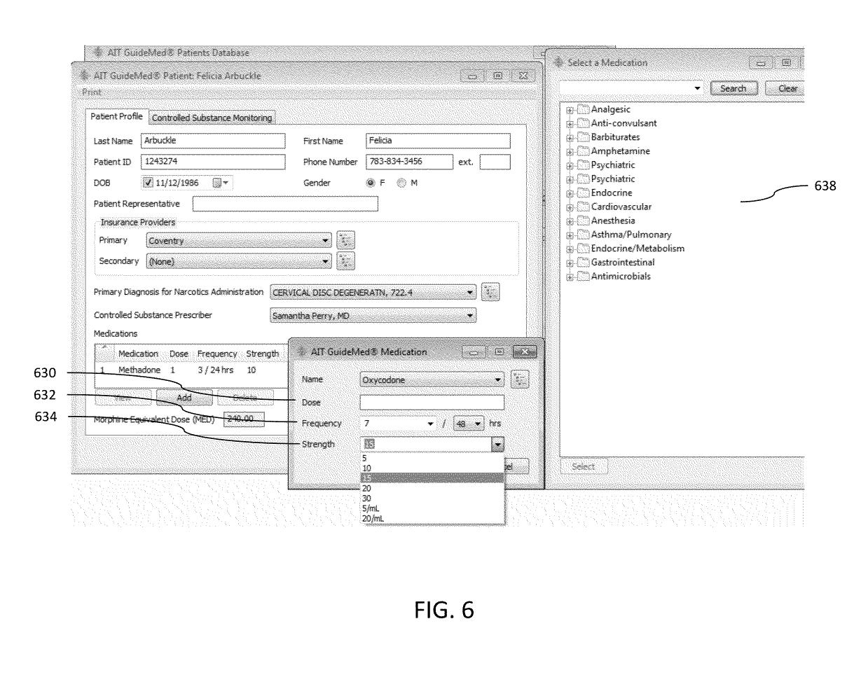

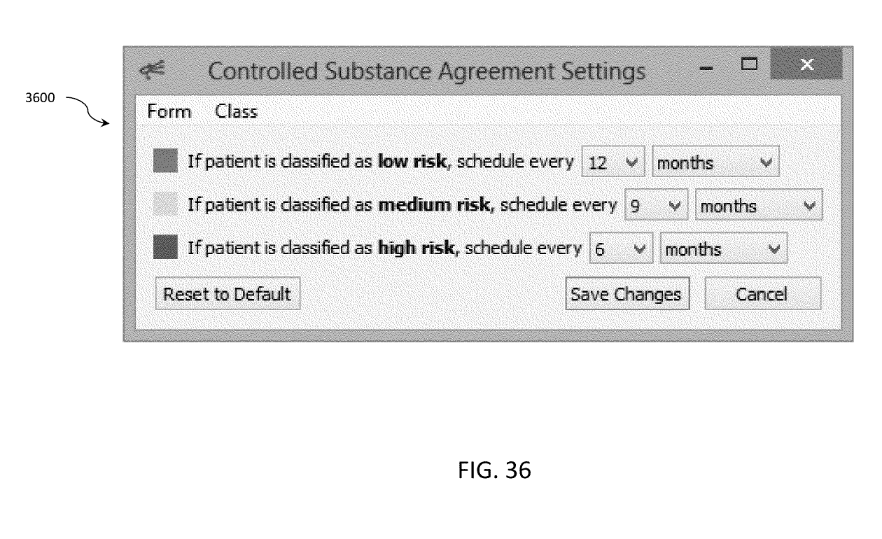

Referring again to FIG. 2, method 200 may also include receiving prescription data (step 220). Prescription data received corresponds to prescriptions taken by a patient and may include information such as a date prescribed, a name of the prescription, a type of prescription, a dosage, a frequency for taking the prescription, a prescribing physician and an intended length of use. Referring to FIG. 3, the bottom of the patient profile form 300 generally provides a Medications space 324 to enter any prescriptions that the patient is currently taking, which may include non-narcotics. To add a prescription, the medication name will be chosen from a tree form 638, as shown in FIG. 6, similar in functionality to the insurance provider tree 414. Administrators will have the ability to customize the medications tree 638 by adding or removing medications (discussed below). After selecting the medication from the medication tree 638, the user or nurse will then enter in the dosage 630 and the frequency 632 for the prescription. If it is a controlled substance and standard doses have been established in tree 638, the standard doses or strengths will automatically populate as options in the Strength box 634. In various embodiments, the frequency 632 for taking the prescription can be selected via the two drop-down lists shown in FIG. 36. In an exemplary embodiment, the options for the period will consist of 24, 48, and 72 hours.

If a nurse enters one or more controlled substances for the patient, the patient's Morphine Equivalent Dose (MED) 326 will be automatically calculated and displayed at the bottom of the patient profile form 300 (see FIG. 3). This number is calculated based on the amount of each controlled substance the patient is taking and the morphine equivalent values of each controlled substance. The user will enter the medication type, number of doses per day, number of pills per dose, and the final MED will be populated at the bottom of the patient profile form 300. The formula used to calculate MED will be the most commonly accepted formula recognized by the American Pain Society. The morphine equivalents will be controlled substances hardcoded into the application, and making a change to a MED will require a modification of the application.

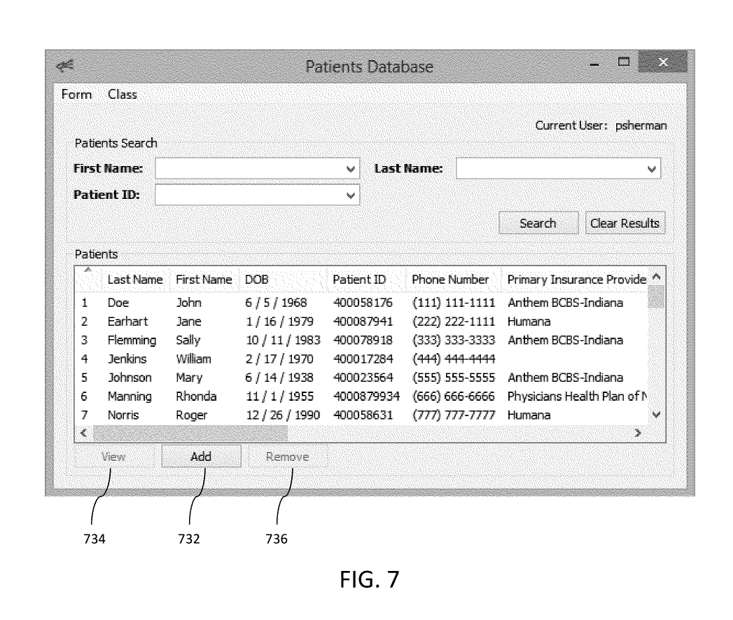

Patient data 132 will be stored in an information database 130 (see FIG. 1). When a nurse or user logs into the information database 130, they will only be able to view the profiles of the patients that belong to the network(s) to which the nurse and/or user is assigned. Referring to FIG. 7, the nurse and/or user will then have the ability to look up, add new, or remove patients via this database form. Nurses can look up patients by first name, last name, and/or patient ID, wherein all will match by substring (i.e., Jo will match Joseph, Joe, Josephine, etc.) and will be combined with ‘or’ logic. Each patient listed will have every field from the patient profile form 300 presented in the list view as a column to be viewed. To add a new patient, the user and/or nurse will select the Add button 732 to open a new patient profile form 300. To view an established patient, the user can highlight the patient, select the View button 734, and the selected patient's profile will be opened. Selecting to add a patient or view a current patient will open either a new patient profile form 300 or the patient profile form of the current patient. Patient profile form 300 will allow the user to enter or update the patient data. To remove a patient, the user can highlight the patient, select the Remove button 736, and the selected patient's profile will be removed. Removing a patient's data will hide them from view, but the data entered for the patient will remain in information database 130.

In further detail and referring back to FIG. 2, method 200 may also include receiving drug data (step 230), receiving risk element data (step 240), and calculating, by a processor 110 (see FIG. 1), a patient's risk level for abusing controlled substances based on the drug data, the prescription data, the risk element data, and the patient data (step 250).

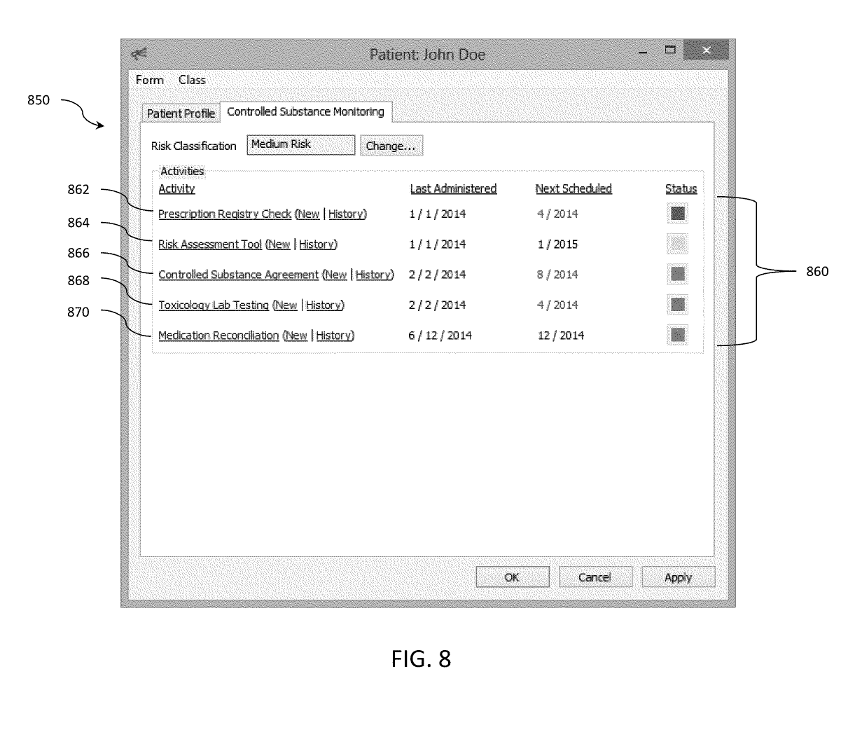

Drug data received may include the drug name, effects of the drug, a dosage, and at least one classification. Referring to FIG. 8, drug data may be entered into controlled substances monitoring tab 850 via several different drug data forms. Drug data forms 860 include a prescription registry check 862, a medication adherence assessment/risk assessment tool 864, a controlled substance agreement 866, a toxicology lab testing 868 and a medication reconciliation 870. Drug data forms 860 are a series of forms for tracking different methods of assessing a patient's risk for abusing controlled substances.

Controlled substances monitoring tab 850, as shown in FIG. 8, found opposite of the patient profile, provides links to the individual activity (assessment) histories. The patient's overall risk classification will be set to the results of the Risk Assessment Tool 864. When a patient is first added to the database, the risk classification level will be set to the lowest level (whatever this may be) and the Last Administered levels will all be blank. The Next Scheduled dates will be determined based on the date the patient was added and their risk classification level. At any time, this classification can be overridden, however, by clicking the Change . . . button and choosing a different classification level. Whenever this override is performed, the results of the risk assessment tool will no longer change the patient's risk classification. The Risk Classification line will appear with a small warning icon ( [symbol] ) beside it, which, when clicked, will show a message indicating that an override has occurred. Any time a user manually modifies the risk classification level, that activity (along with their username) will be recorded. Updating the patient's risk classification (either manually or automatically) will reset the “Next Scheduled” dates, if applicable.

Still referring to FIG. 8, clicking the blue link text on any activity displays the most recent results of the activity. Clicking the New link beside the activity will show a form for entering in new results. Finally, clicking the History link will show all of the history of the given patient for the given activity. The forms for the individual activities will be discussed below. Each activity has three properties listed next to it. These three properties include last administered, wherein the date corresponds to the last date on which the activity was performed, next scheduled, wherein the date corresponds to the date on which the activity needs to be performed again, and status, wherein the status of an activity will be represented with a color and/or icon. The next scheduled date will not be adjusted if the activity is missed (it will always stay on schedule). If a “Next Scheduled” date has passed, it will appear in red. Additionally, the color of the status will be determined by the latest results of each activity. If there are no latest results for the activity, it will display as green. In general, the status column can be interpreted as green indicating no concern, yellow indication potential concern, and red indicating concern/unexpected findings. While FIG. 8 shows the status as colored boxes, the status may also be signified by symbols such as a check mark, a flag or a caution sign. In an exemplary embodiment, the status will display a green check mark to indicate no concern, a yellow caution sign to indicate potential concern and a red flag to indicate high concern. The status updates are made automatically when a new activity is performed and the results are established.

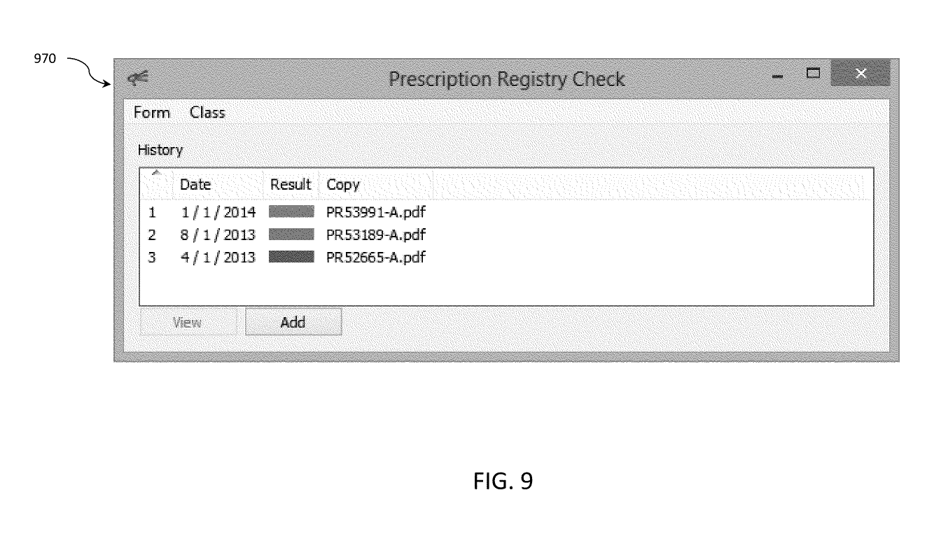

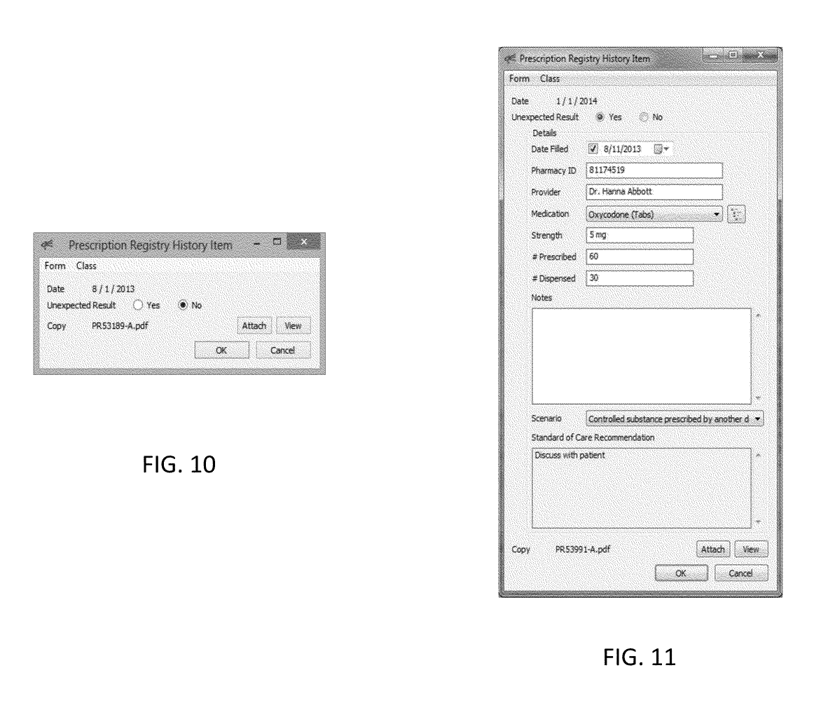

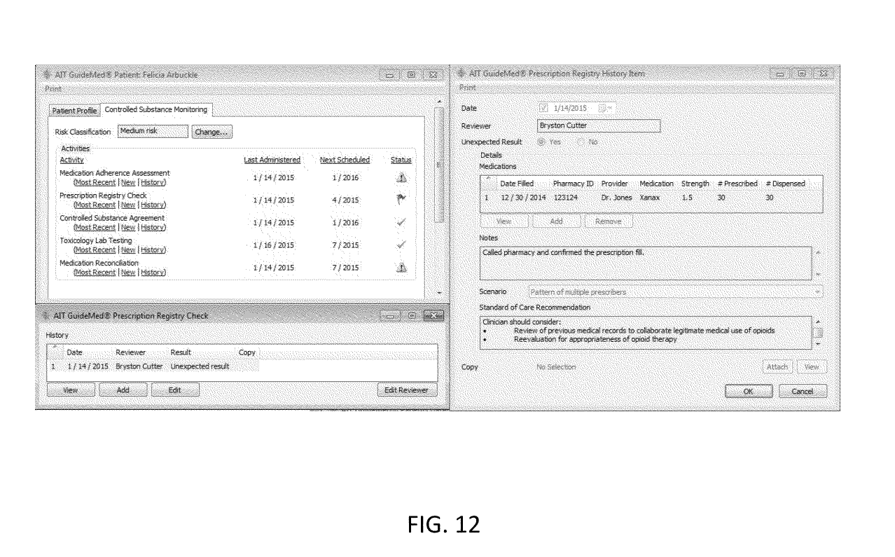

Referring to FIG. 9, the Prescription Registry Check form 970 contains a history of all checks performed on the prescription registry for the given patient. The result of a check is represented with one of two colors, wherein green indicates no unexpected result and red indicates unexpected result. To record that a prescription registry check was performed, the Add button is clicked on Prescription Registry Check form 970 or the New link is selected on controlled substance monitoring tab 850. This presents a form similar to that seen in FIG. 10. If the check resulted in no unexpected findings, the staff member reporting the check simply selects “No” for unexpected results and (optionally) attaches a Copy of the results (PDF or screenshot). If the check results in unexpected findings, the staff member will click “Yes”. Clicking “Yes” will cause a Details section to appear in the form (as seen in FIG. 11). The Details section is used to detail the specifics of the unexpected finding, which includes the medication, the provider of the medication, the date the medication was filled, the pharmacy ID, the number prescribed, the number dispensed, and a scenario. The options for the scenario drop-down will be network-based. When the scenario is selected, the standard of care recommendation will be automatically filled. The scenarios and their corresponding standard of care recommendations will be determined and managed by an administrator (discussed below).

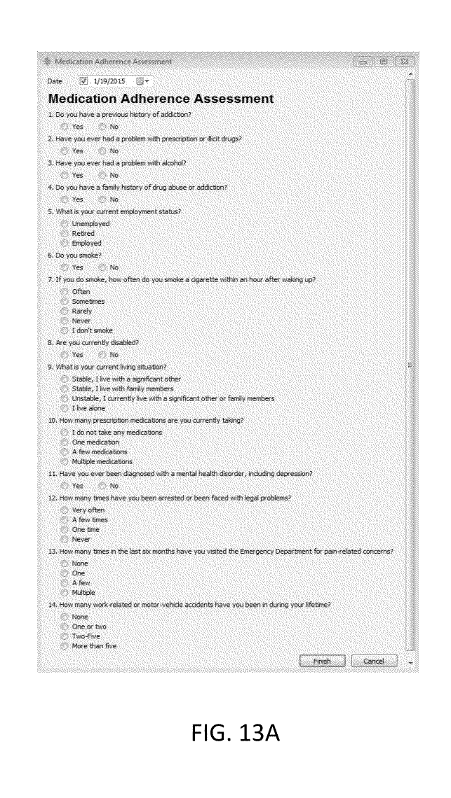

By selecting the History link under Prescription Registry Check on controlled substance monitoring tab 850, the user will be presented with a list of all prior checks for the patient, similar to the form shown in FIG. 12. Any individual activity can be viewed by highlighting that activity and selecting View. The Most Recent link will also present the most recent activity summary for the patient. The past views will not allow the user to make changes and will be a static summary of that individual activity. To edit any individual result in the History list, the user can highlight the activity, select the Edit button, and make any necessary changes. The user must document any reasons for making changes in a free form text box.

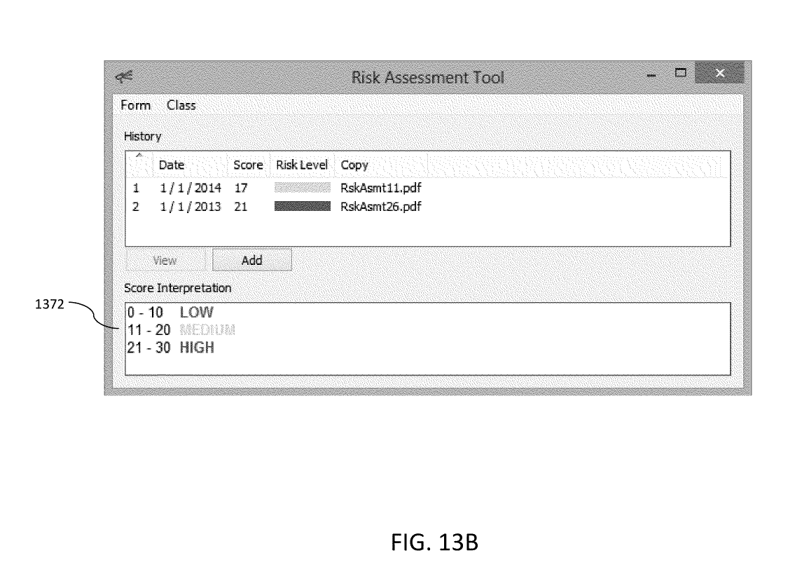

In further detail, each network will have its own Medication Adherence Assessment or Risk Assessment Tool 864. This tool will consist of a series of questions, each of which has a quantifiable set of answers, wherein each answer is assigned a point value. An embodiment of Medication Adherence Assessment/Risk Assessment Tool 864 is shown in FIG. 13A. By adding up the point values of each question for a particular patient, a risk level can be assigned to said patient. The specifics of the risk assessment tool (i.e. the questions that it is made up of) can be constructed using this system (discussed below). The risk assessment tool history will contain a list of dates on which risk assessments were performed (see FIG. 13B). The result of an assessment is represented with one of two to four levels (colors), which will be determined by the network administrator (discussed below). For the reviewer's convenience, there will be a read-only Score Interpretation field 1372 below the history items, which shows a score-to-risk key based on point values of the risk assessment tool 864.

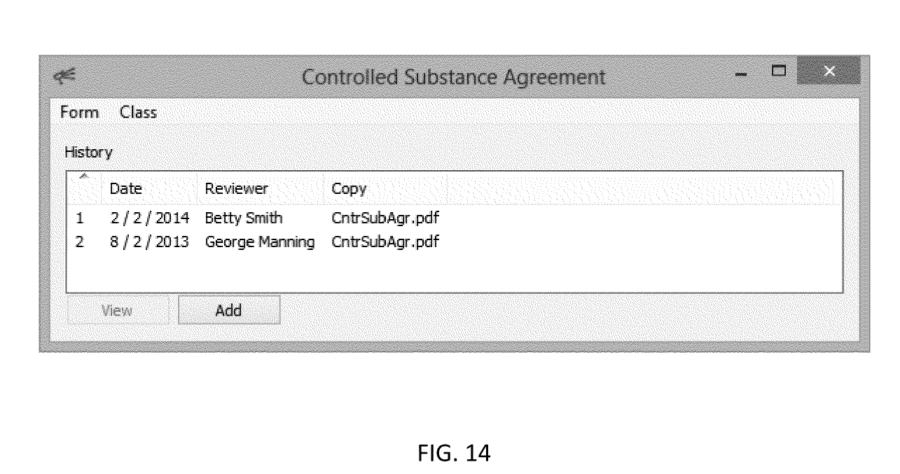

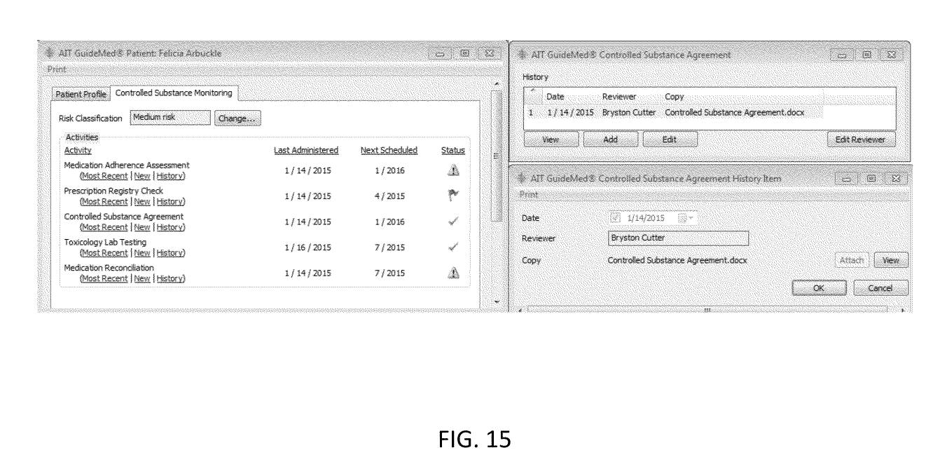

Referring now to Controlled Substance Agreement 866, whenever the patient signs a new copy of a controlled substance agreement, the new copy is catalogued in the Controlled Substance Agreement history (see FIG. 14). By selecting the History link under Controlled Substance Agreement on controlled substance monitoring tab 850, the user can view all past Controlled Substance Agreement activities. Selecting the History link opens the History window, shown in FIG. 15, with all previous administrations listed for the patient. The

Controlled Substance Agreement history will track the dates on which the agreement was signed, who reviewed the agreement, and a copy of the patient's signed agreement form. Any individual activity can be viewed by highlighting the activity line item and selecting View. By selecting View, a static screen will be presented for the user to view the activity. To make any edits to previously administered activities, the user will highlight the list item, select the Edit button, make changes, and denote the reason for the edits in a free form text box. By selecting the New link under controlled substance agreement 866, a window will open for the user to enter a new controlled substance agreement for the patient. The user will enter the date of administration and attach a copy of the agreement into the file. The reviewer field, shown in FIG. 15, will automatically populate with the current user's full profile name.

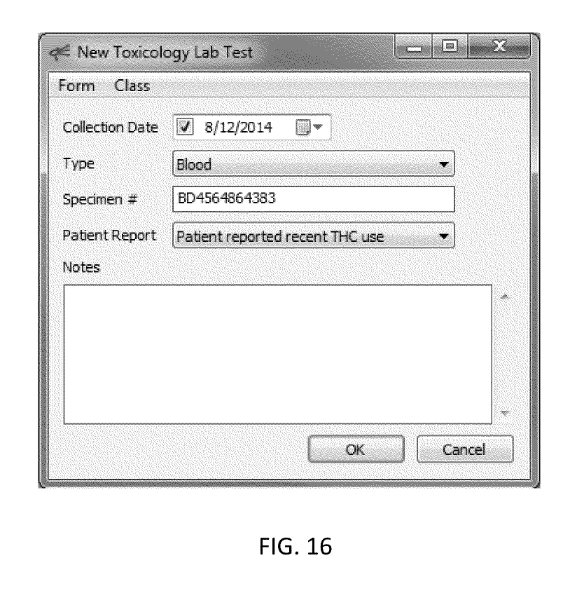

With reference to Toxicology Lab Testing 868, whenever toxicology lab testing is performed, a nurse and/or user can record the test in the Toxicology Lab Testing history. Adding a new test will result in a form similar to that seen in FIG. 16. This form will default the collection date to the current date and require that the nurse and/or user select what type of lab test was performed (blood, urine, or saliva) as well as a specimen number, which will be used to identify the lab test. Lastly, the nurse and/or user can select a Patient Report from the drop-down. The options for the Patient Report drop-down will be set by the network administrator (discussed below). The collection and results of this testing will be reported in the toxicology lab testing activity log. The log will record the date on which the lab testing was performed, the type of testing performed, the specimen number, the date the specimen was collected, and the result of the testing. The result of a test is represented with one of two colors, wherein green indicates no inconsistent results and red indicates inconsistent results. Of course, other indicators may be used. When the nurse and/or user first enters that a sample was collected, the status of the toxicology test will be set to “Pending”. The test will remain in this status until the test has been reported by an outside provider. The system will be setup to periodically look for a file (Excel or CSV) in a shared location with an agreed upon structure that will allow it to automatically change the status of toxicology labs tests to “Reported”. An existing outsider provider's system must output files periodically to support this interface.

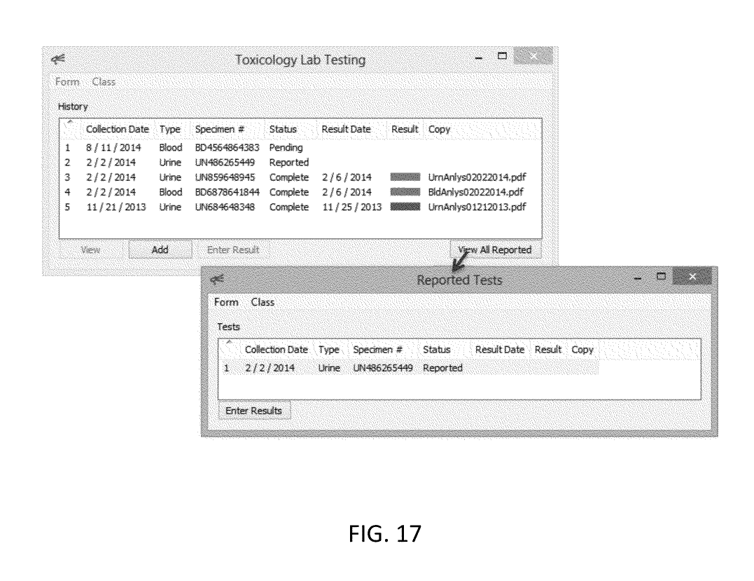

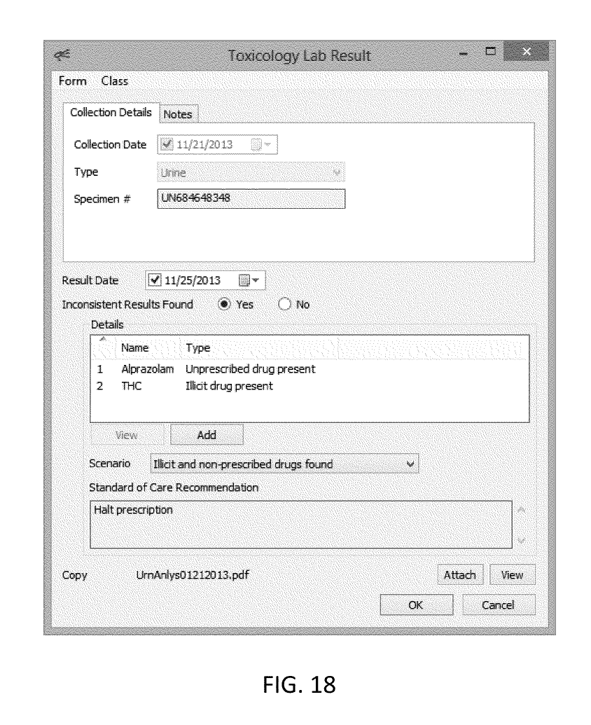

Once a lab test has the status of “Reported”, a nurse or user can then select any test from the Reported Test window (see FIG. 17) and enter the results from the report (see FIG. 18). Since lab test results can accumulate, there will be an option to “View All Reported” tests, which will show only those tests with status “Reported.” When entering a result for a test, the nurse and/or user will start by entering the date the result was received and whether or not the testing revealed any unexpected or inconsistent results. When a lab test results in inconsistent results, the toxicology lab result form will expand to allow the details of the results. In the example shown in FIG. 18, the patient had both unprescribed and illicit drugs found in their system. Based on the drugs found by the lab testing, the staff member who is entering the results will select a scenario, which will auto-populate the standard of care recommendation. While FIG. 18 shows the Inconsistent Results details and the scenario section as their own separate fields, in various embodiments, the Inconsistent Results details and the scenario may be combined in one combined field.

In the “Drugs Found” list box, there will be several “Types” that can be assigned to a medication/drug including prescribed drug not present, unprescribed drug present, illicit drug present, alcohol present, abnormal specimen validity, and concentration concern.

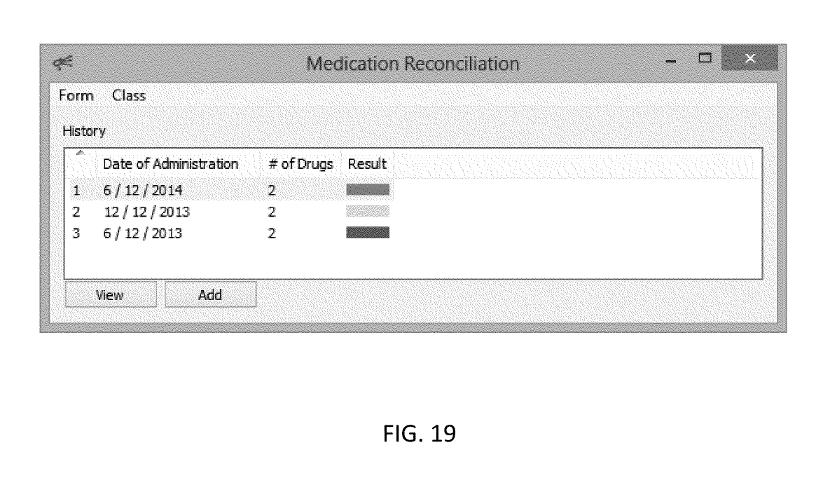

Referring to the next activity, medication reconciliation 870 is a formal process for creating the most complete and accurate list possible of a patient's current medications and comparing the list to those in the patient record or medication orders. The medication reconciliations performed for a patient will be tracked in the medication reconciliation history form (see FIG. 19). The medication reconciliation history tracks the dates on which the counts were performed, the number of drugs that were counted, and the overall result of performing the counts. The result of a medication reconciliation is represented with one of three colors, wherein green indicates no concern, yellow indicates a potential concern and red indicates a major concern. Again, other indicators may be used.

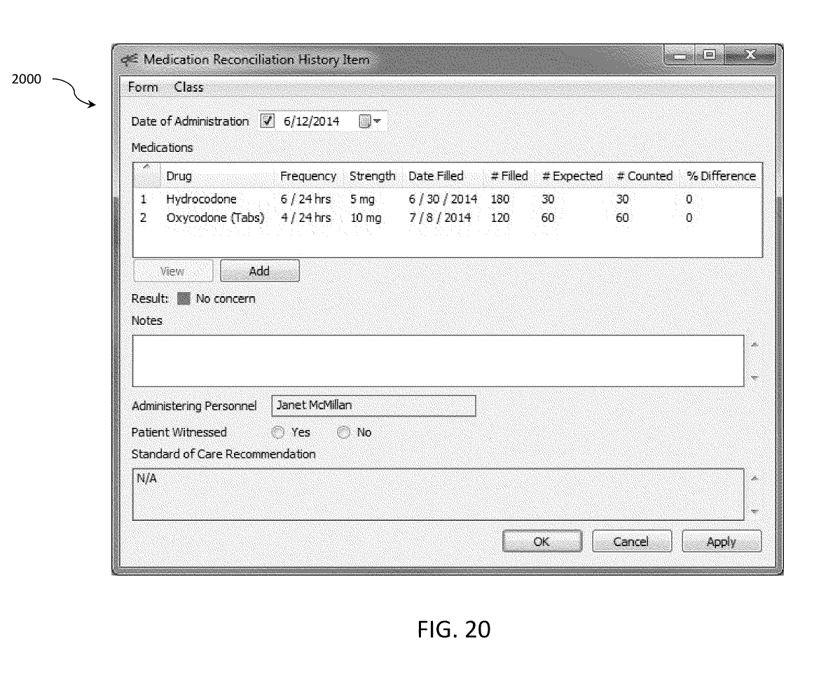

When a user enters results for a medication reconciliation, they will do so using a form similar to that shown in FIG. 20. This form has fields for entering the date of the count, the medications that were counted (as well as the prescription description and instructions), and the result. Note that the result is set automatically. The result is set automatically using ranges for percent difference, which are determined by an administrator (discussed below). While FIG. 20 shows the results in percent difference, in various embodiments, the result may be in number of days difference. The worst result of each of the medication counts will be displayed. This means if 10 medications are counted and 9 of these counts result in “no concern” but one count results in “major concern”, the overall result of the medication reconciliation will be “major concern”. A standard of care recommendation will be automatically set based on the overall result. Additionally, in various embodiments, the form may further include a Reviewer field and/or Did Not Show check box.

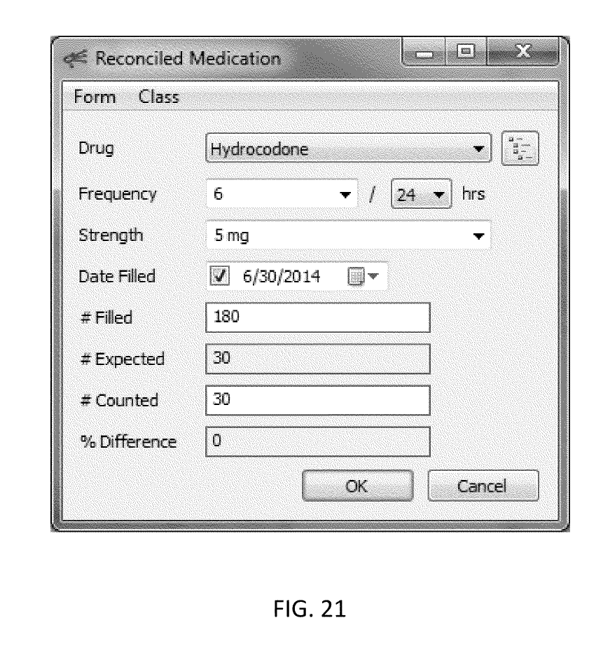

The medication reconciliation form 2000 also has a field for entering in notes (which is optional) and a field that displays the administering personnel (which is automatically populated). An embodiment of a form for entering an individual medication count is shown in FIG. 21. The top of the medication count form will be used to select the medication being counted, the prescribed frequency, and the prescribed strength. The “Frequency” and “Strength” values can be chosen from a drop-down, which will pull its choices from pre-entered frequency and strength values that are entered by an administrator (discussed below). The bottom half of the medication count form will be used to record the date, fill amount, and count of the medication. The number expected and the percent difference will be calculated automatically based on the rest of the information in the form. While FIG. 21 shows the result in percent difference, in various embodiments, the result may be shown as the number of days difference.

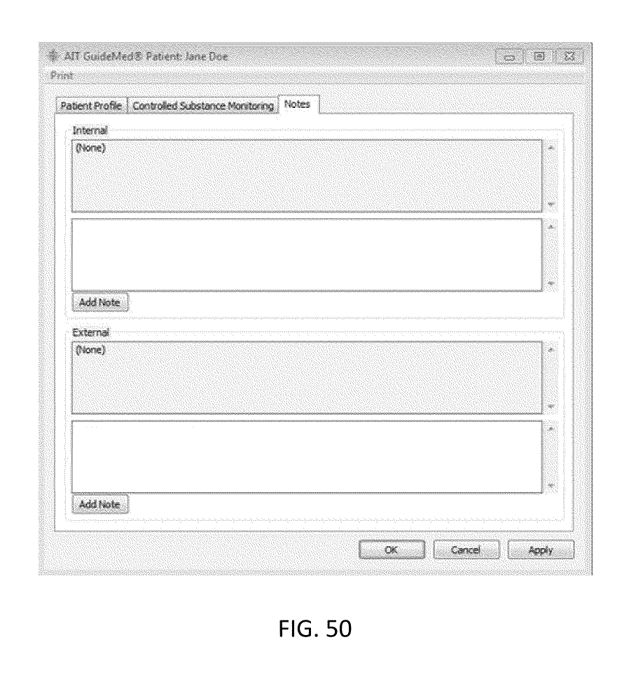

In various embodiments, a Notes tab may also be used opposite the Patient Profile form tab 300 and the Controlled substances monitoring tab 850. As shown in FIG. 50, the user may enter Internal notes or External notes. Internal notes are only visible to the user, while External notes are visible on the patient dashboard printouts.

As discussed above, many forms include options and/or values that can be set by a system administrator and/or network administrator. System administrator options refer to options that affect the entire system, while network administrator options refer to options that affect a single network inside the system.

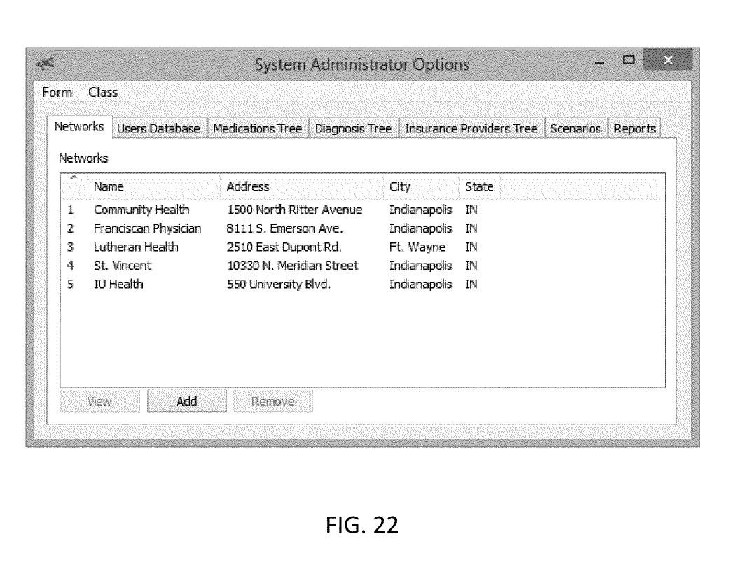

System administrators will be in charge of entering and managing several lists of information including networks list, users list, medications tree and insurance providers tree. FIG. 22 shows the form for the System Administrator Options, open to the Networks list tab. The System Administrator Options form further includes tabs for the User Database, the Medications Tree, the Diagnosis Tree, the Insurance Providers Tree, and the Scenarios.

The Networks tab in the System Administrator Options form will contain information about each network that will use the software to perform controlled substances monitoring. System administrators can add, remove, or edit networks from this list.

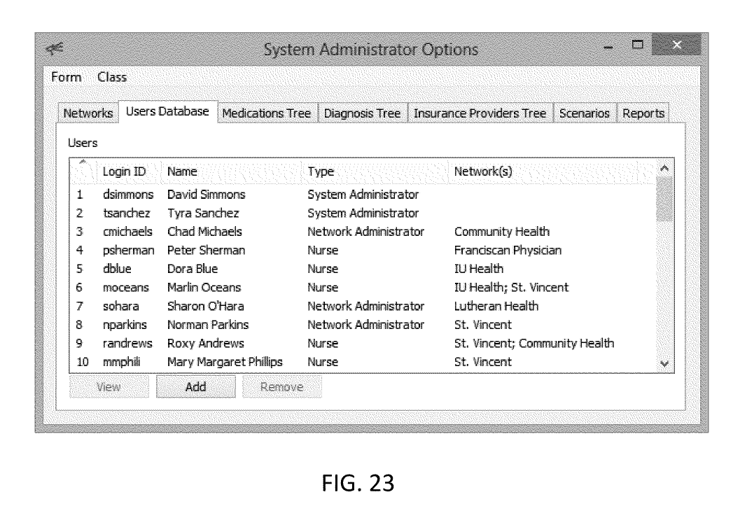

System administrators will also have access to the User Database via the User Database tab, which is seen in FIG. 23. The software system will need to be accessible to many users over many networks. Thus it will keep a database of these users, which is fully accessible to system administrators and partially accessible to network administrators. Users in the user database will be identified by a login ID, but will also have additional properties that can be managed. These properties may include user type and networks. For user type, each user will have an assigned “type”, which will dictate what kind of actions the user can perform in the system. The three user types include system administrator, network administrator and nurse. A system administrator can view and change system and network administrator options. A network administrator can view and change network administrator options. A nurse can enter and manage patient data. For networks, network administrator and nurses should only have access to patient data for the networks to which they are employed. Thus, if a user is given one of these types, the system administrator who is entering the user information must choose to which network(s) the user is assigned. System administrators can edit any user information in the user database. However, system administrators will most likely only be entering in the information for system administrators and the main network administrators for each network. Nurses and additional network administrators will be entered by the network administrators in each network.

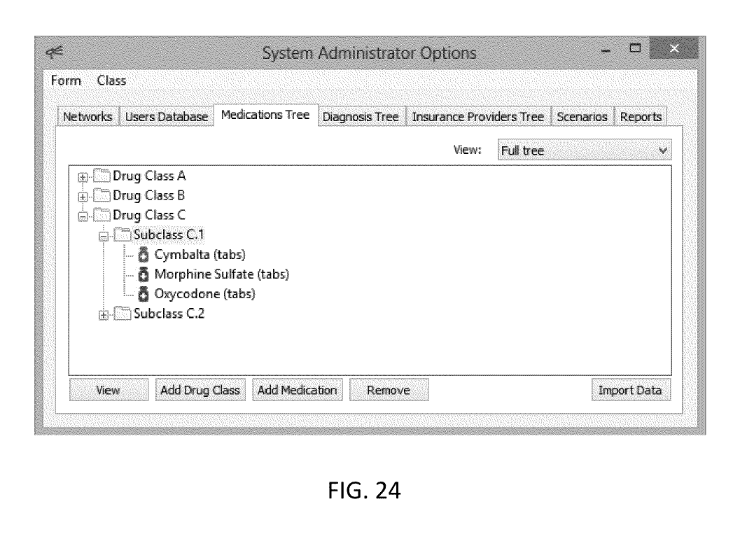

The Medications Tree tab and the Insurance Providers tab of the System Administrator Options form are used for managing the Medications tree 638 and the Insurance Providers tree 414. FIG. 24 shows an embodiment of the System Administrator Options form for populating the Medications tree 638. The contents of these trees will be used by nurses when choosing medications and insurance providers on the patient profile form (refer back to FIG. 3) as well as other patient information forms.

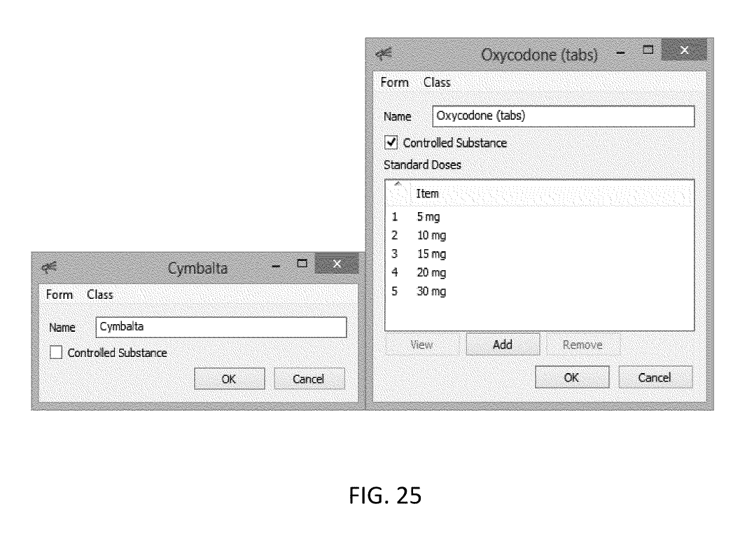

The medications tree will be organized by drug class, wherein the administrator entering the medications can specify the names and order of these drug classes. Each drug class will then contain subclasses. The subclasses will contain lists of medications. An embodiment of a form for entering a medication is seen in FIG. 25. After entering the medication's name, there is a checkbox to indicate whether or not the drug is a controlled substance. If the checkbox is checked, a new section will appear beneath it. This section is for entering standard doses for the drug, which will then be used by the Reconciled Medication form seen in FIG. 21. If a drug is a controlled substance, it will appear in the medications tree with a blue icon. Otherwise, the drug will appear with a red icon. The “View:” drop-down above the medication tree can be used to show just controlled substances (or the full tree, as depicted in FIG. 24).

The Medications Tree tab will also include an option to Import Data. System administrators can use this option to import a list of medications into the tree from an external spreadsheet file (Excel or CSV). The spreadsheet file must consist of three columns: Drug Class, Subclass, and Medication. These column names will help the software place each medication in the proper position in the tree.

The Diagnosis Tree tab and Insurance Providers tab of the System Administrator Options form will function similarly to the Medications tab. However, diagnoses will be tracked only by name (and organized by letter) and insurance providers will be tracked only by name (and organized by state)—no additional information will be required.

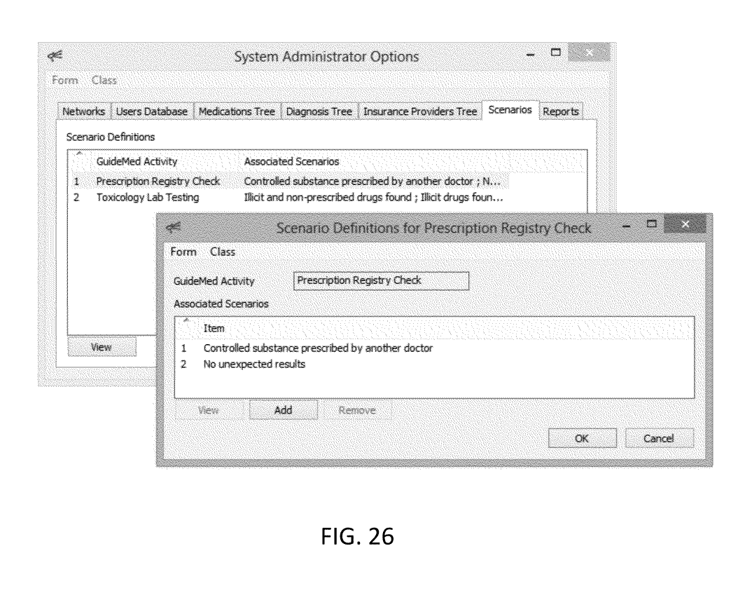

In the Scenarios tab of the System Administrator Options form, the system administrator will define the lists of possible scenarios for any of the applicable controlled substances monitoring tests. Each of the activity scenario lists can be viewed by clicking the View button, and “Associated Scenarios” can be added or removed by clicking on the “Add” or “Remove” button in the scenario Definitions screen. In FIG. 26, the system administrator has defined two different scenarios for the Prescription Registry Check. System administrators define scenarios so that network administrators can define standard of care recommendations for each scenario (discussed below).

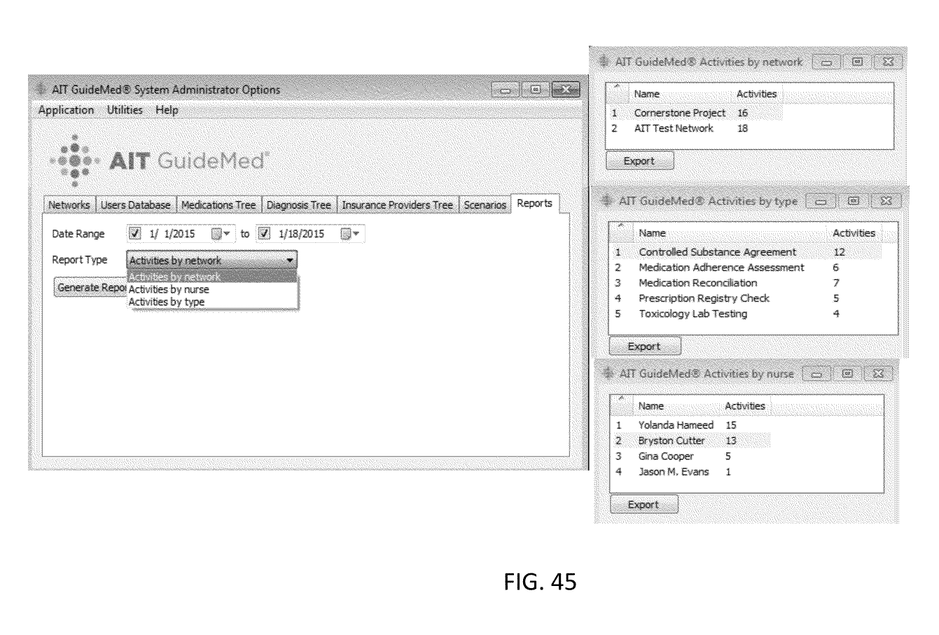

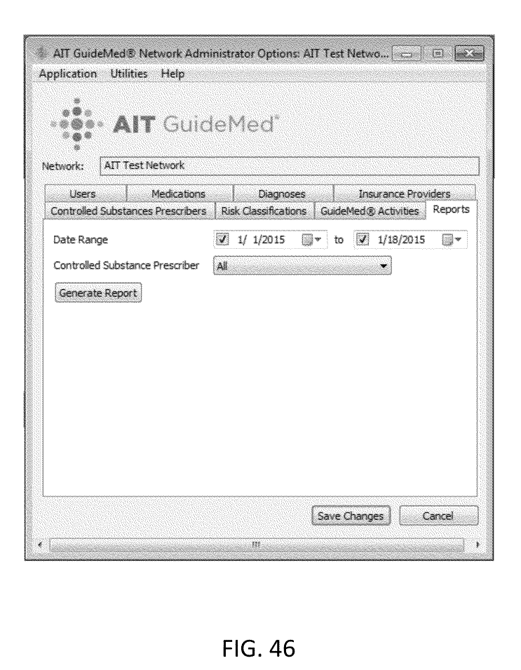

In various embodiments, the System Administrator Options form and/or the Network Administrator Options form may further include a Reports tab or section, as shown in FIGS. 45 and 46. Selecting the Reports section allows the user to pull lists of activities performed by nurses over periods of time. By choosing a data range and whether to view the patients by network, by nurse, or by type, the reports produced may be specifically tailored. The number of activities will be shown once the “Generate Report” button is selected. To see more detailed information about each activity listed, the user can select “Export” and an excel spreadsheet can be created and saved to look through all of the information by activity. Additionally, in various embodiments, the Reports tab may further include a Survey Report section, wherein the System Administrator may pull survey or Medication Adherence Assessment/Risk Assessment results per network for a date range.

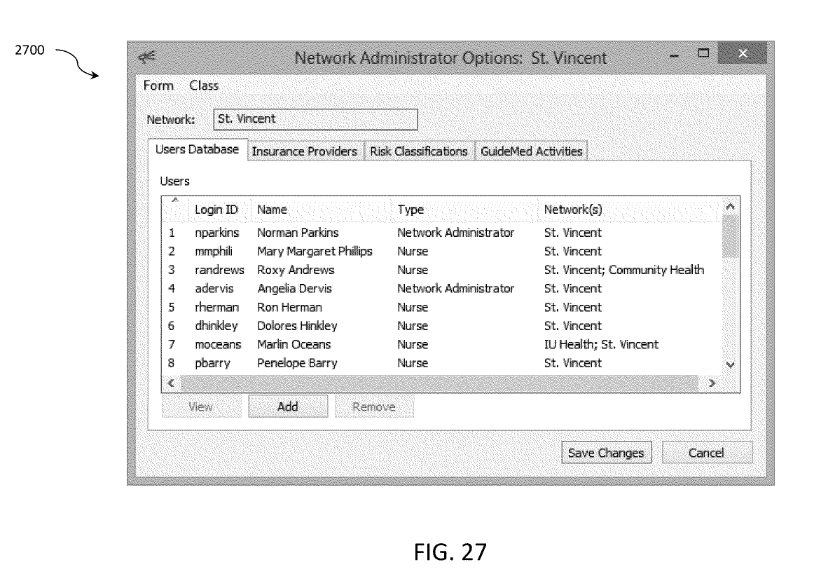

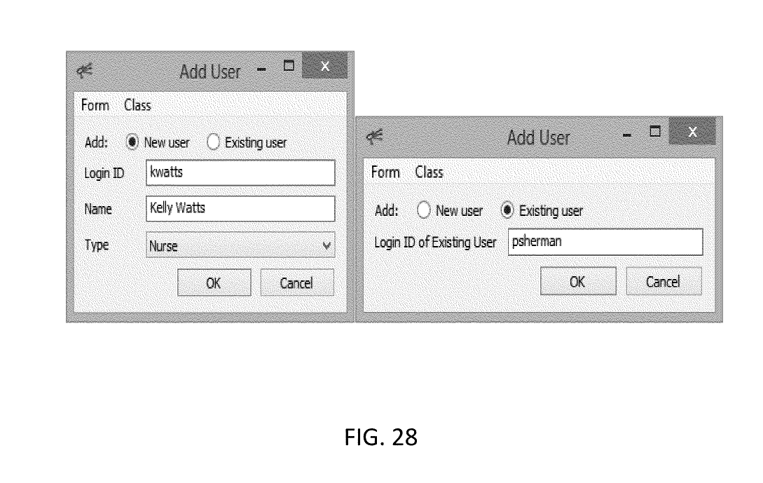

Network administrators will be in charge of entering and managing several lists of information including users lists for the network to which they are assigned, standard insurance providers, risk classification levels and activities and their options. FIG. 27 shows the Network Administrator Options form 2700 open to the Users Database tab. The Network Administrator Options form further includes tabs for Insurance Providers, Risk Classifications, and Controlled Substances or Narcotics Monitoring Activities. The Users Database for a network looks similar to the Users Database for the system. However, only users from the network appear in the list. When the network administrator adds users, the users will be automatically assigned to the given network. Adding a new user as a network administrator will show an Add User form, seen in FIG. 28. The network administrator can either add the new user as a new user, which will require the creation of the user's login ID, or an existing user, which will require that the user be matched by login ID. If the administrator is adding the user as an existing user, this means that the user currently belongs to another network but needs to also belong to the network administrator's network.

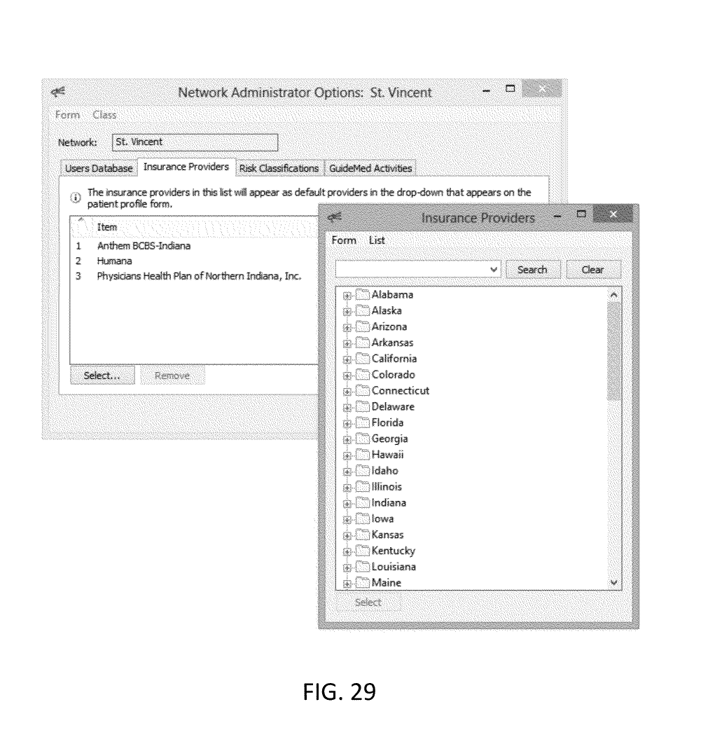

The Insurance Providers tab of the Network Administrator Options form may be used to edit the Insurance Providers list. The Insurance Providers list for a network will be used to populate the insurance providers drop-downs on the patient profile form 300 (refer back to FIG. 3). The providers listed here should be the most common providers for the given network. The Select . . . button in the Insurance Providers tab will show the insurance providers tree, which will allow the network administrator to add one or more insurance providers to their list (see FIG. 29).

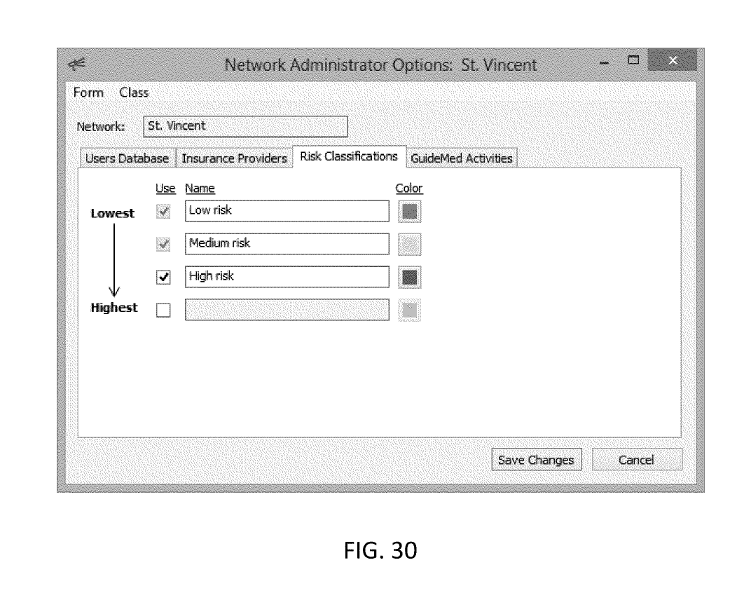

The Risk Classifications tab is used to define 2-4 levels of risk classification that can be assigned to a patient (refer back to the overall classification setting on the controlled substances monitoring form seen in FIG. 8). In the Risk Classification tab, shown in FIG. 30, the network administrator can choose how many levels of risk classification there should be, name each level, and choose a corresponding color. In FIG. 30, three risk levels have been defined: low risk, medium risk, and high risk. If the network administrator wanted to add a fourth level above “high risk”, they could check the check box next to the fourth edit box to enable the line and enter a name and color.

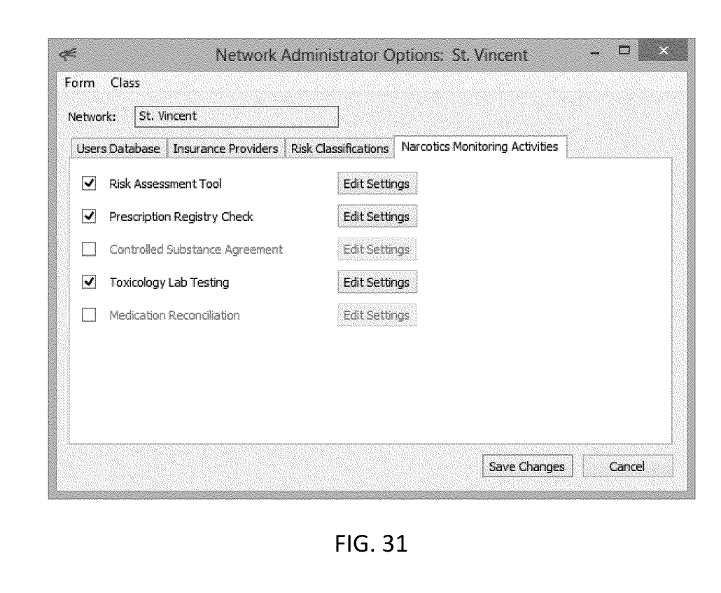

The final tab in the Network Administrator Options form 2700 is the Controlled Substances Monitoring Tools tab, as shown in FIG. 31. This tab allows the network administrator to select which activities will be performed on patients in a network. The activities that are selected in this tab will comprise the list seen in the Controlled Substances Monitoring form (refer back FIG. 8). The network administrator must check at least one tool in the list of controlled substances monitoring activities. When an activity is checked for use, the network administrator then has the option to edit the settings corresponding to the activity.

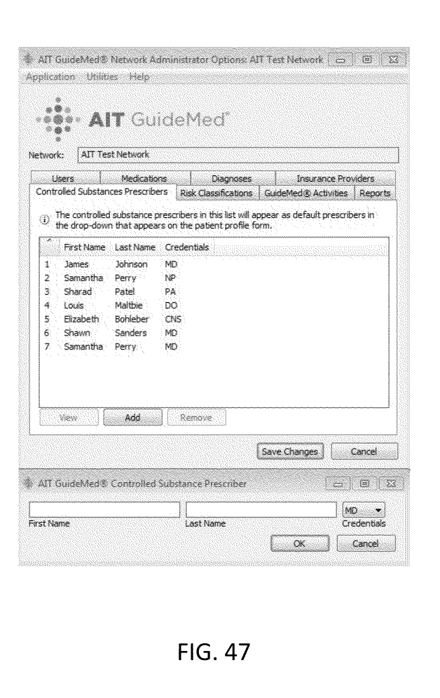

In various embodiments, Network Administrator Options form 2700 may further include a Controlled Substance Prescribers tab as seen in FIG. 47. By selecting the Controlled Substance Prescribers tab, the user is allowed to load all prescribers into the network profile that will then show up on the Patient Profile form 300 as dropdown options for all patients. When adding new prescribers, the user will click the Add button and fill out the First Name, Last Name, and choose credentials from the dropdown list to create a new prescriber. The user can remove any prescribers from the default prescribers drop-down list by highlighting the prescriber and clicking Remove.

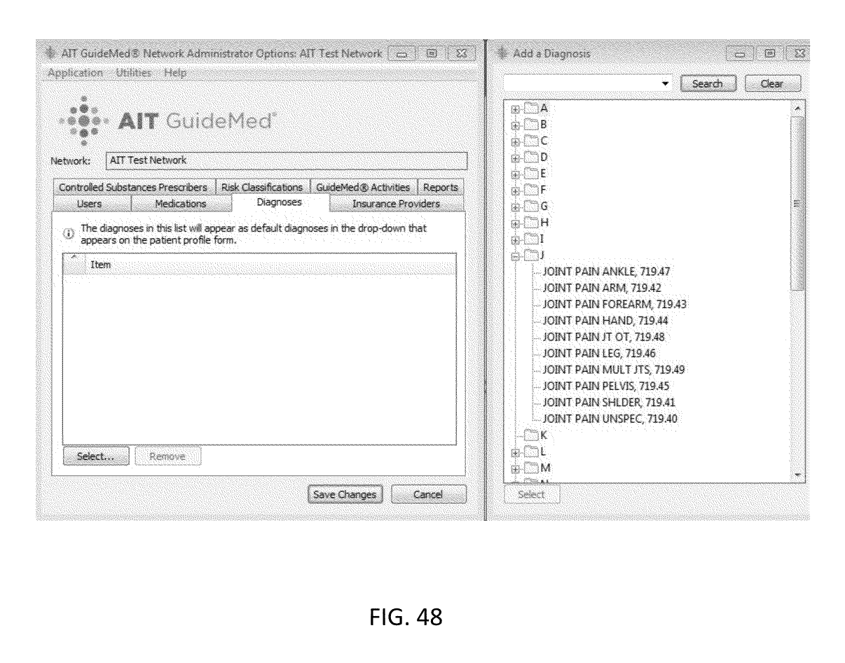

Furthermore, in various embodiments, Network Administrator Options form 2700 may further include a Diagnoses tab as seen in FIG. 48. By selecting the Diagnoses tab, the network administrator is able to choose which diagnoses they expect to see most often in their network population for ease of use in completing the patient profiles. To add new diagnoses to the preferred list, the user clicks the “Select” button, searches from the master Diagnosis list, and chooses each medication they want to add.

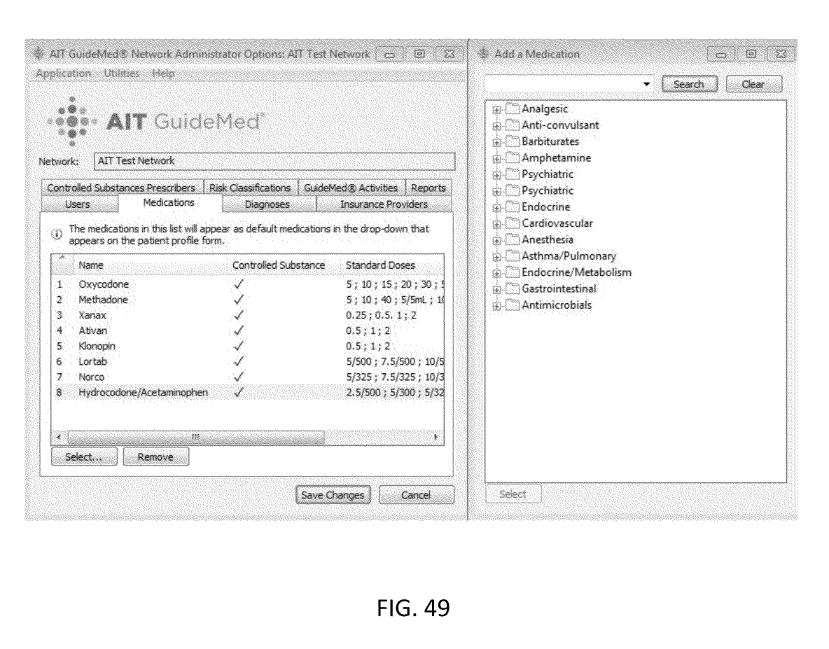

Additionally, in various embodiments, Network Administrator Options form 2700 may further include a Medications tab as seen in FIG. 49. By selecting the Medications tab, the network administrator is able to choose any medications that they expect to use in the patient profile or medication reconciliations sections of the software. The network can choose as many “preferred” medications as they want. To add new medications, they click the Select button and choose from the medication tree by searching through the software medications.

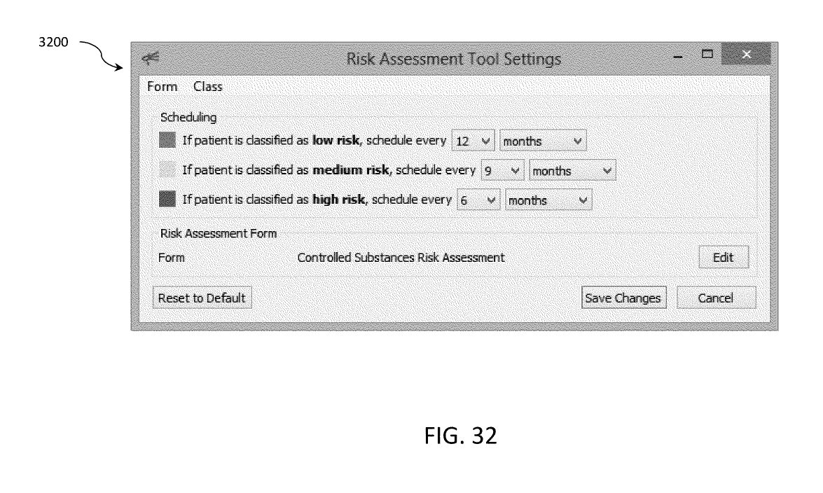

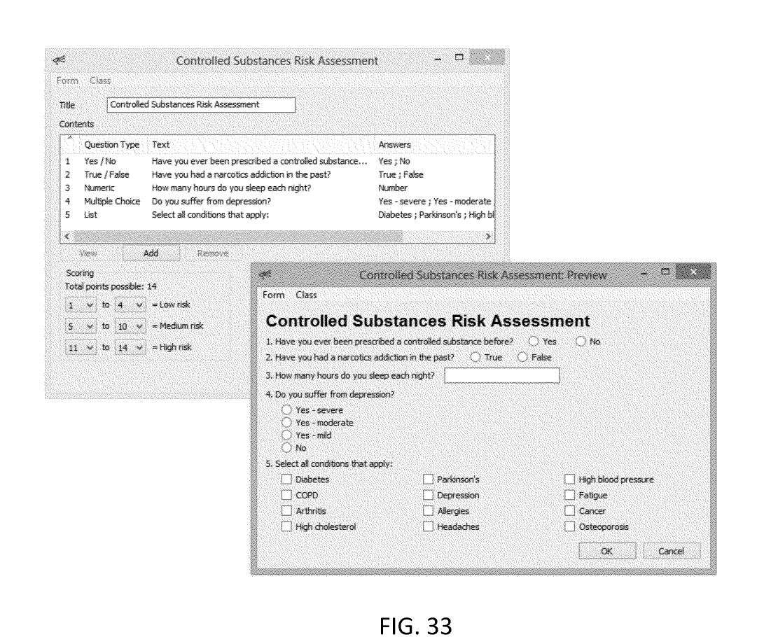

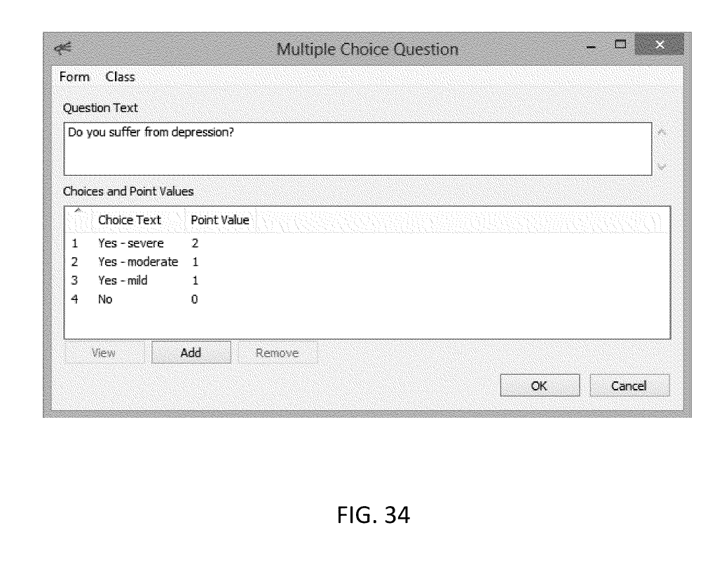

In further detail, the network administrator may additionally edit the settings corresponding to the activities to be performed by the software. The Risk Assessment Tool Settings form 3200, shown in FIG. 32, is broken down into two sections: Scheduling and Risk Assessment Form. The Scheduling section allows an administrator to set scheduling protocol for performing the risk assessment tool based on a patient's risk classification. For each risk level (as defined in the Risk Classifications tab of the Network Administrator Options form, seen in FIG. 30), the administrator can pick how often (in days, weeks, months, or years) the risk assessment should be performed. The Risk Assessment Form section will contain a link to the current risk assessment tool outline (if applicable). The administrator can edit the contents of the risk assessment tool from this section. When an administrator edits the risk assessment tool form, they will be shown a definition form and a preview form (see FIG. 33). The definition form is used to set the title, contents (questions), and scoring mechanism of the risk assessment tool. The preview form shows what the finished product will look like based on the choices made in the definition form. The method for designing the controlled substances risk assessment tool contents will involve the administrator “defining” different questions of varying types. Each type will have its own method of assigning point values. For instance, the 4^{th} question is a multiple choice question. The form for entering in the contents and point values for this question might look like FIG. 34.

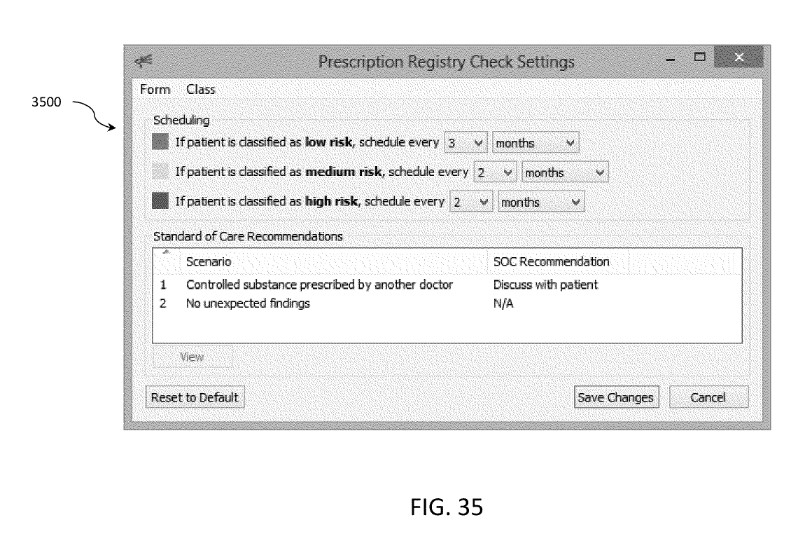

The Prescription Registry Check Settings form 3500, shown in FIG. 35, allows an administrator to set scheduling protocol for prescription registry checks based on a patient's risk classification. For each risk level (as defined by the system administrator in the Risk Classifications tab, seen in FIG. 30), the administrator can pick how often (in days, weeks, months, or years) the prescription registry check should be performed. The prescription registry check settings form also has a section devoted to defining the standard of care recommendations. Recall that the system administrator will define scenarios for each of the applicable controlled substances monitoring tools (refer back to FIG. 26). The network manager will then be responsible for entering standard of care recommendations for each scenario. These recommendations will appear automatically when a nurse chooses a scenario from a scenario drop-down on a controlled substances monitoring tool form. While not shown in FIG. 35, in various embodiments, the Prescription Registry Check name may be customized. For instance, the name may be edited to include the network name.

The Controlled Substance Agreement Settings form 3600, shown in FIG. 36, allows an administrator to set scheduling protocol for procuring new signed copies of the controlled substance agreement based on a patient's risk classification. For each risk level (as defined by the system administrator in the Risk Classifications tab, seen in FIG. 30), the administrator can pick how often (in days, weeks, months, or years) the controlled substance agreement should be signed.

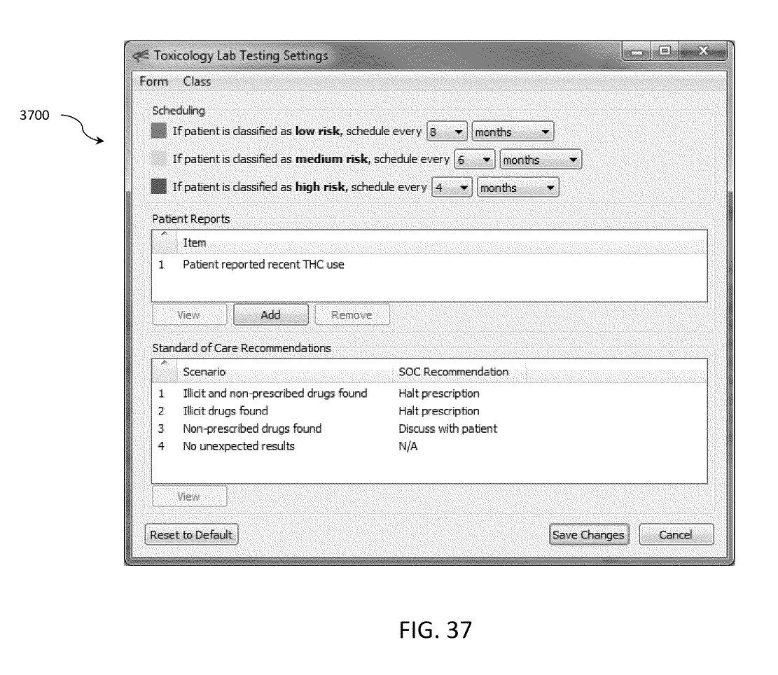

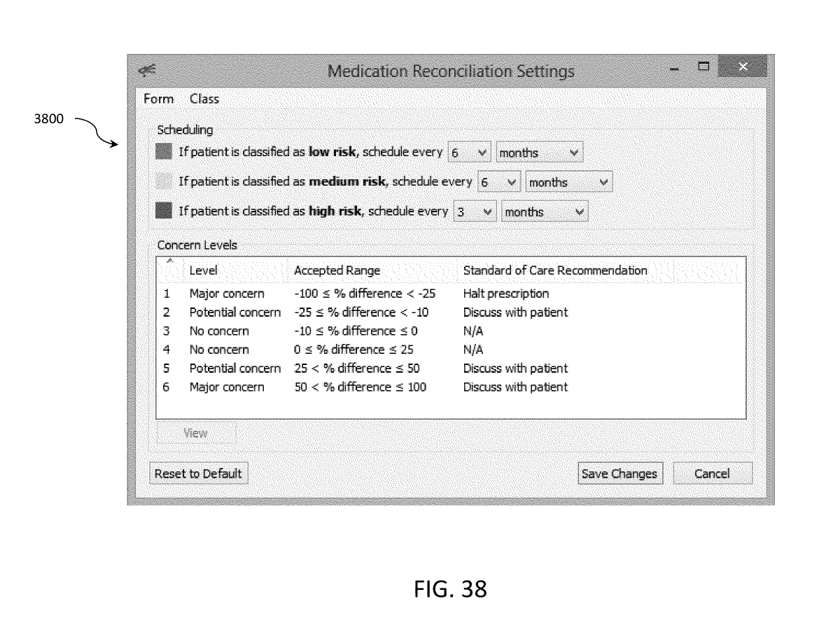

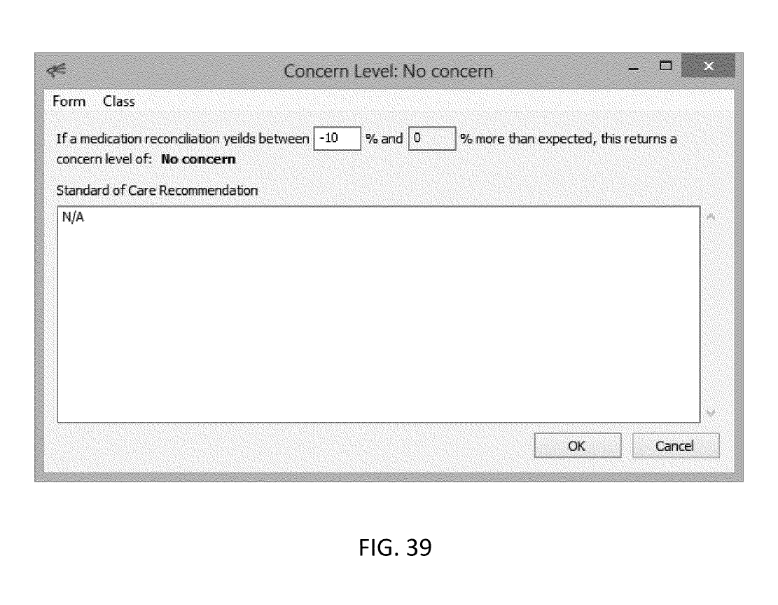

The Toxicology Lab Testing Settings form 3700, shown in FIG. 37, allows an administrator to set scheduling protocol for lab testing based on a patient's risk classification. For each risk level (as defined by the system administrator in the Risk Classifications tab, seen in FIG. 30), the administrator can pick how often (in days, weeks, months, or years) the toxicology lab testing should be performed. Note that while FIGS. 37 and 38 display very short standard of care recommendations, there will be sufficient space to include much more information (see FIG. 39). The toxicology lab testing settings form also has sections devoted to defining the patient reports and the standard of care recommendations. Recall that the system administrator will define scenarios for each of the applicable controlled substances monitoring tools (refer back to FIG. 26). The network manager will then be responsible for entering standard of care recommendations for each scenario. These recommendations will appear automatically when a nurse chooses a scenario from a scenario drop-down on a toxicology lab testing form.

The Medication Reconciliation Settings form 3800, shown in FIG. 38, allows an administrator to set scheduling protocol for performing medication reconciliations based on a patient's risk classification. While not shown in FIG. 38, in various embodiments, the administrator or use may also be able to customize the name of the Medication Reconciliation entries. For each risk level (as defined by the system administrator in the Risk Classifications tab, seen in FIG. 30), the administrator can pick how often (in days, weeks, months, or years) the medication reconciliation should be performed. The medication reconciliation settings form also has a section devoted to defining the concern levels associated with performing a medication count. As previously stated, a medication reconciliation can have one of three results: no concern, potential concern, and major concern. Each of these results is correlated with two percentage difference ranges: a negative range, which indicates that fewer pills than expected were counted, and a positive range, which indicates more pills than expected were counted. For example, if patient John Doe comes in for a medication reconciliation and is found to have 40 pills when he is expected to have 50, he has 20% fewer pills than expected. Thus, his “% difference” result is −20%. The medication reconciliation settings form 3800 allows the network administrator to assign percentage ranges for each of the three levels (e.g., none, potential or major). While FIG. 38 shows the accepted ranges in percent difference, in various embodiments, the accepted ranges may be in number of days difference. Each level is also assigned a standard of care recommendation, which automatically appears when the nurse enters the results of the count. FIG. 39 shows the form for editing the settings for the negative or no concern range.

Furthermore, for analyzing all the data within system 100, there are two types of summary reports that may be produced by system 100. The first kind of summary report will be patient-based and will contain only data relevant to a specific patient's controlled substances monitoring results. Physicians will be the main beneficiary of this type of report. The second type of summary report will be system-based and will contain data statistics about history records kept by the software. System administrators for the application will be the main beneficiary of this type of report.

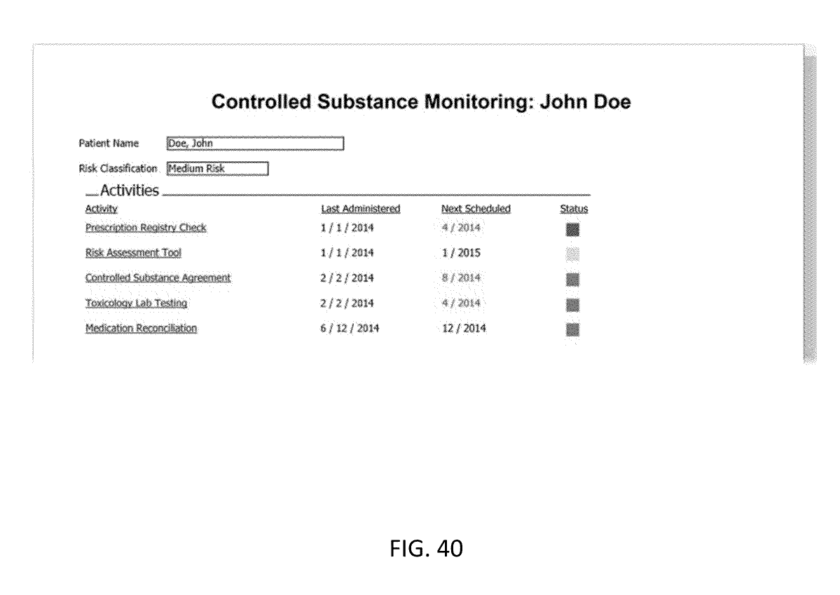

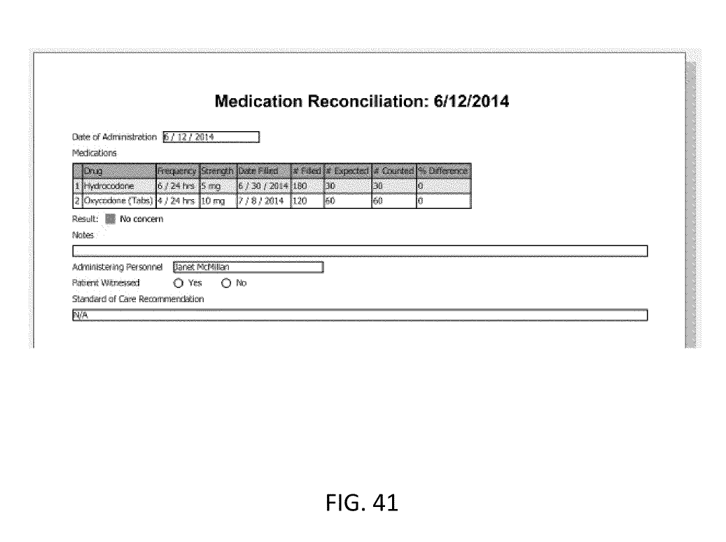

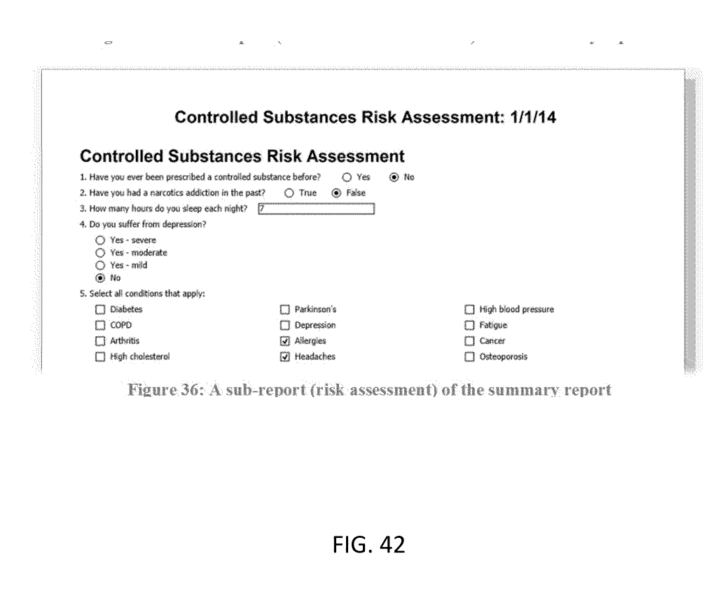

The purpose of the patient summary report is to provide a clean, easy-to-read synopsis of the findings of the controlled substances monitoring process for the given patient. Patient summary reports will be printed by nurses and entered into the appropriate physician's medical records system. To print a summary report, the nurse will open a patient's profile form and select an option in the menus to “Print Summary Report”. The nurse will then be prompted to select a date and all data up to and including this date will be gathered and organized for printing. The summary report will consist of a cover page, which will display the overall results of the controlled substances monitoring activities (see FIG. 40), pages containing the details of the most recent occurrence of each monitoring activity that occurred between the current date and the selected date (see FIGS. 41 and 42), wherein the Standard of Care Recommendation will be included for each monitoring activity occurrence, and pages containing the attachments corresponding to each of the most recent occurrences of each monitoring activity, if applicable. While FIG. 40 shows the status of the activities as colored boxes, in various embodiments, the status may be shown as a symbol such as a check mark, a caution sign or a flag. Additionally, while FIG. 41 shows the results in percentage difference, in various embodiments, the result may be shown in number of days difference.

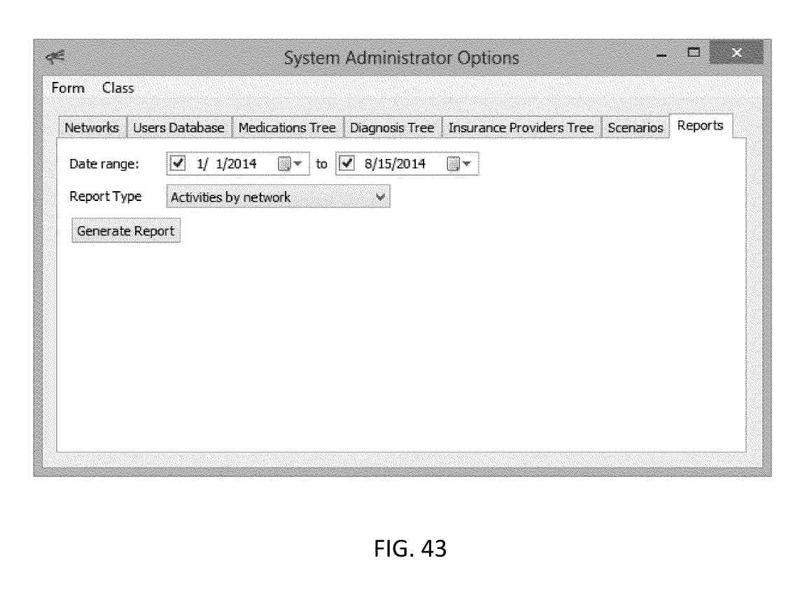

The purpose of the system summary reports is to get a statistical overview of usage in the software. Since this information is mainly desired by the system administrator, it appears on the System Administrator Options form in the Report tab (see FIG. 43). The report settings shown in FIG. 43 would generate a report that shows the number of activities performed per network (recall that the networks are defined in the Networks tab of the System Administrator Options form, as seen in FIG. 22).

An activity is a monitoring action taken by a nurse in the software. All history items are recorded and stored in an external database. Interaction with the data can therefore be done through the Reports tab of the System Administrator Options form (see FIG. 43) or through an external database analysis tool. The Reports tab will offer report types including activities by network, activities by nurse and activities by type (type=each type of controlled substances monitoring tool).

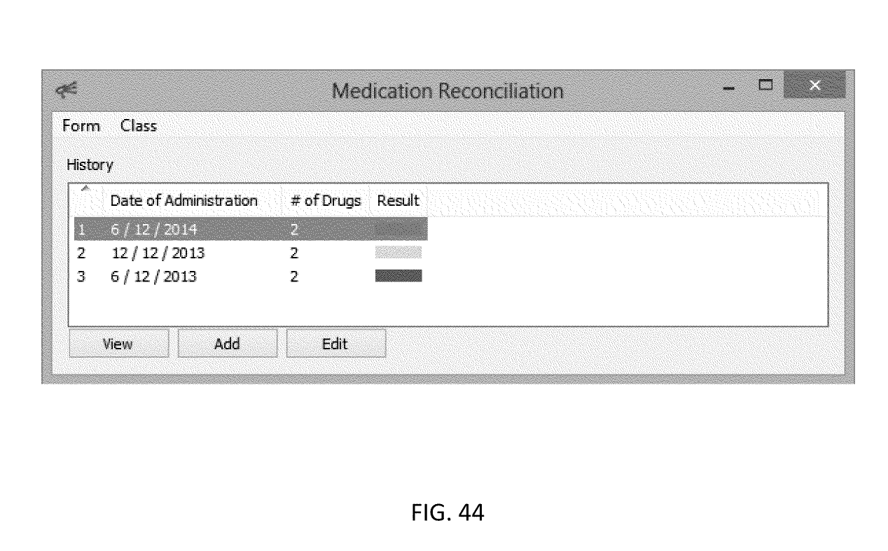

Any time a nurse adds or edits an item in a patient's controlled substances monitoring history, this is considered an activity. Each record entered into the system will include a field that records the user who entered it. By recording the user who performed each activity, system and network administrators will be able to collect statistics regarding how the software is being used. Each history list will include an Edit button that will allow nurses or administrators to correct mistakes. Nurses will only have the ability to edit the latest activity, but administrators may edit any activity. When a nurse selects the latest activity from the activity history list (see FIG. 44), an Edit button will appear, which will always be present for administrators. This button will show an editable version of the activity, while View will always show a read-only version of the activity. The editable version of the activity will have an extra field on its form titled “Reason for Edit”. The nurse or administrator who is making the edit will need to fill out this field before submitting their changes. Once the editor makes the desired changes to the activity and clicks OK, a brand new item will appear, and the previous item will remain in the history. Both items will include the user ID of the nurse or administrator who entered the item, allowing administrators to track the values in the fields prior to and after they are edited.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A method for monitoring medication intake activity comprising:
receiving patient data;
receiving prescription data;
receiving drug data;
receiving risk element data; and
calculating, by a processor, a patient's risk level for abusing controlled substances based on the drug data, the prescription data, the risk element data, and the patient data.

2. The method of claim 1 further comprising comparing the prescription data with the drug data.

3. The method of claim 1, wherein the risk element data includes a quantifiable set of answers.

4. The method of claim 1 further comprising signaling when a patient is scheduled to receive a next activity based on an evaluation of the prescription data and the drug data.

5. The method of claim 1, wherein the patient data includes a name, an identification number, a date of birth, a gender and an age.

6. The method of claim 1, wherein the prescription data includes a date, a name, a type, a dosage, a frequency, a prescribing physician and a length of use.

7. The method of claim 1, wherein the drug data includes a name, a dosage and at least one classification.

8. The method of claim 1, wherein at least one of the prescription data and the drug data include an identification of at least one controlled substance.

9. The method of claim 8 further comprising calculating a morphine equivalent dose of the at least one controlled substance.

10. The method of claim 1 further comprising storing the patient data, prescription data and drug data in a database.

11. The method of claim 1 further comprising providing recommendations for future treatment based on at least one of the patient data, the prescription data and the drug data.

12. The method of claim 1 further comprising scheduling a next event for determining the patient's subsequent risk level based on the patient's current risk level.

13. A system comprising:
a processor; and
a non-transitory, computer-readable storage medium including installation software which installs medication monitoring software, the medication monitoring software including:
an information database stored on the computer-readable medium accessible by the installation software and having a plurality of files, wherein at least one of the plurality of files contains patient data, at least one of the plurality of files contains prescription data of a patient, and at least one of the plurality of files contains medication data of the patient; and
a plurality of computer-readable instructions stored on the computer-readable medium accessible by the processor, which when executed by the processor enables the processor to:
receive a request to perform the installation of the medication monitoring software;
install the medication monitoring software in response to the request to perform the installation;
determine a risk level for the patient by performing a comparison between the patient's prescription data contained in the information database and the patient's medication data contained in the information database; and
display the risk level via an output device.

14. The system of claim 13, wherein the output device is a display of a computing device housing the processor.

15. The system of claim 13, wherein the system is configured to periodically change the status of a toxicology lab test report.

16. The system of claim 13, wherein the executed plurality of computer readable instructions may further enable the processor to signal when a patient is scheduled to receive a next activity based on an evaluation of the prescription data and the drug data.

17. The system of claim 13, wherein the system is configured to provide recommendations for future treatment based on at least one of the patient data, the prescription data and the drug data.

18. The system of claim 13, wherein the risk level is a score, the score being within one of a range signifying a low risk, a range signifying a medium risk and a range signifying a high risk.

19. The system of claim 13, wherein the executed plurality of computer readable instructions may further enable the processor to schedule a subsequent determination of a risk level based on the patient's current determined risk level.

20. A non-transitory computer-readable data storage medium comprising instructions that, when executed by a processor, cause the processor to perform acts comprising:
receiving patient data;
receiving prescription data;
receiving drug data;
receiving risk element data; and
calculating a patient's risk level for abusing controlled substances based on the drug data, the prescription data, the risk element data, and the patient data.
